(19) United States
(12) Patent Application Publication
(10) Pub. No.: US 2026/0204914 A1
(43) Pub. Date: Jul. 16, 2026

(54) Systems and Methods of an Uncertainty Platform for Risk Assessment and Control Room Operations for Energy Grid Operators

(71) Applicant: Midcontinent Independent System Operator, Inc. (‘MISO"), Carmel, IN (US)

(72) Inventors: Jason Howard, Russiaville, IN (US); Congcong Wang, Carmel, IN (US); Long Zhao, Fishers, IN (US); Abdul-Rahman Mohammed, Fishers, IN (US); Stephanie Steider, Indianapolis, IN (US); Chen-Hao TSAI, Inver Grove Heights, MN (US); Mitchell Gottlieb, Westfield, IN (US); Adam Simkowski, Carmel, IN (US); Neela Krishnamurthy, Carmel, IN (US); Daniel Uber, Allen Park, MI (US); Haleigh Gronwold, Carmel, IN (US); Evan Sattler, Woodstock, GA (US); Arezou Ghesmati, Carmel, IN (US); Jason Dossett, Westfield, IN (US)

(21) Appl. No.: 19/564,831

(22) Filed: Mar. 12, 2026

Related U.S. Application Data
(63) Continuation of application No. 19/252,733, filed on Jun. 27, 2025.
(60) Provisional application No. 63/665,664, filed on Jun. 28, 2024.

(51) Int. Cl. H02J 3/38; G05B 13/02; H02J 3/00; H02J 13/10; H02J 101/24; H02J 101/28; H02J 103/30

(52) U.S. Cl. CPC H02J 3/38; G05B 13/0265; H02J 3/003; H02J 3/004; H02J 13/10; H02J 2101/24; H02J 2101/28; H02J 2103/30

(57) ABSTRACT

A computer implemented platform for managing risk and uncertainty for energy grid operators, includes: a forecasting application providing probabilistic forecasts or uncertainty quantification for load, weather, and renewable-energy forecasting aspects; a risk analytics and visualization application providing availability risks of generation, fuel and net scheduled interchange and displaying at least portions of the availability risks in a geographic overlay; and a net uncertainty application dynamically setting reserve requirements based on periodic risk profiles.

### CROSS REFERENCE TO RELATED APPLICATIONS

This application is a continuation application of U.S. patent application Ser. No. 19/252,733 filed Jun. 27, 2025, which claims benefit of U.S. Provisional Application Ser. No. 63/665,664 filed Jun. 28, 2024, the entire disclosures of which are incorporated herein by reference in their entireties

### TECHNICAL FIELD

The current disclosure pertains to technical operations of energy grid operators such as RTO (Regional Transmission Organization) and ISO (Independent System Operator). Such operators manage power transmission grids and wholesale electricity markets. In North America, they are the entities responsible for coordinating the flow of electricity across the grid, ensuring grid stability, and facilitating competitive energy markets in deregulated regions. For the purposes of this disclosure, the terms “energy grid operator,” “grid operator,” “operator,” “RTO” and “ISO” may be used interchangeably.

### BACKGROUND

Rapid energy transition is driving an increasingly volatile risk profile for Market and Grid Operations. Historically, control rooms for energy grid operators provide a clear picture of grid conditions with the largest uncertainty covered by Contingency Reserves. In the transitioning fleet, uncertainties largely increase in its magnitude and arise from multiple dimensions. Some grid operators, for example, have more than 40 GW of wind and solar resources in its generation mix. In the next 10 to 20 years, the pace of more weather-dependent resources coming online is expected to accelerate. In addition, load profiles and availability of thermal generation fleet has been challenged by more and more frequent extreme weather events (hurricanes, winter storms, etc.). For RTOs that are interconnected, neighbouring conditions can significantly affect interchange schedules. Probabilistic forecasts and various sources of data are being developed to help manage the uncertainties. However, most energy and market management systems are not able to directly process, manage or use such probabilistic data, and grid operations need cohesive and centralized information to make timely decisions.

Energy grid operator portfolios have experienced a rapid transition in the past few years, with coal and gas generation being replaced by renewables. This transition is expected to accelerate in the next 10-20 years, where the capacity and production of utility-scale wind and solar with very low production costs are expected to grow fast. The integration of wind and solar is changing the characteristics of grid operators' supply to maintain system reliability and market efficiency. Furthermore, grid operators may have large geographic footprints with diverse weather patterns and complicated congestion issues. Additionally, many regions in the U.S. have experienced more frequent extreme weather in the past 10 years. These factors contribute to greater variability and uncertainty during grid operations.

Current grid-operator energy forecasting capabilities encounter several limitations and challenges. First, the uncertainties a grid operator has to manage arise from various sources such as load, solar, and wind forecasting, generation and fuel availability etc. and these factors can be correlated. Second, each forecasting aspect (i.e., load, wind, or solar forecasting) involves multiple forecasts from various vendors, whose performance varies across regions and time. Third, there is a lack of method to evaluate and select forecast scenarios from different NWP weather models and various vendors. Finally, energy forecasting is transition towards the probabilistic forecasting paradigm. But most of grid-operator's energy and market management system are not able to directly process the probabilistic forecasts. As a result, how to generate and select energy forecasts with improved accuracy, chronology, and uncertainty quantification remains as a critical question for grid operations with variability and uncertainty.

Another issue with prior systems is that data is stored at different locations (databases, or flat files, or website), making the maintenance and quality control very challenging. Operations Risk Assessment team, control room operators and other analytic teams must log into different systems to view various elements.

Prior risk assessment and scenario generation is not fully automated. Prior processes and methods use offline python code to manually analyze weather scenario performance and adjust load forecasts that feed into operations. Advanced analytical capability and automation will be extremely useful. For example, the heatwave in June of 2022, based on trend and performance analysis of two weather scenarios, a grid operator applied a weather scenario from vendor #1 for load forecast in north/central region and applied a weather scenario from vendor #2 for load forecast in east/south. The analysis and adjustment were time-consuming and very manual.

Another issue with prior systems is that operators do not have an ability to select a non-default load or renewable scenario to feed into reliability process. For example, during winter storm Elliott in 2022, a grid operator's load forecast struggled because there was no tool/platform to adjust hourly forecasts in real-time.

Another issue with prior systems is that renewable forecasting performance from multiple vendors is currently monitored offline, and the tool/platform does not support control room personnel to view the forecasting performance and switch to a different vendor in real time. Renewables may be dispatched down significantly due to congestion. The dispatched down quantity in forward process (2-3 days out) is difficult to predict, making it hard to assess how much renewables the grid operator can count on in operations planning stage when forecasted wind generation is high.

Another issue with prior systems is that there is no joint quantification of net load uncertainty to represent collective risks of actual condition deviating from the forecasts. There is a need to aggregate many risk factors (weather, load, renewable, generation fail-to-start or fail to run, wind dispatch down, NSI). For example, during winter storm Elliott in 2022, the available “most likely” scenarios painted a picture for the few days leading to the capacity emergency in real-time, but the materialized deviation was more than 25 GW and the grid operator declared capacity emergency during operating day.

Consequently, there is a need for an intelligent platform in risk assessment and control-room operations. A comprehensive platform is needed to provide the capabilities, flexibility, and scalability required to manage variability and uncertainty in large electric grids.

### SUMMARY

To effectively manage uncertainties in the transitioning fleet and to enable data-driven decisions, the current disclosure provides an operations Uncertainty Platform. The Uncertainty Platform transforms control room risk assessment and management from a long-standing static and deterministic framework to a dynamic and probabilistic paradigm. The platform leverages cloud technologies to enable centralized data availability and distributed domain-driven applications. Utilizing globally defined standards and microservice integration patterns, the cloud-native architecture of the Uncertainty Platform serves as the secure and scalable foundation for the application of risk visualization and advanced analytics. This platform transforms the traditional static and deterministic way of managing the grid to more dynamic and probabilistic fashion enabled by cloud technologies, advanced data analytics, and machine learning techniques.

The Uncertainty Platform includes three primary risk applications or functionalities: (1) probabilistic forecasts and uncertainty quantification: for load, wind, and solar, multiple forecasting scenarios are established based on numerical weather prediction models, or from multiple vendors for wind and solar. These forecasting scenarios are used to quantify uncertainty. Dynamic model switching/assembling algorithms are provided to improve forecasts. (2) Risk analytics and visualization: availability risks of generation, fuel and interchanges are assessed leveraging risk analytics and weather geographic overlay. A geographic overlay of thermal generation fleet and temperature forecast is built to assess the risk of generator fail to start during extreme cold weather. An overlay of gas generation fleet and gas pipelines quantified generation capacity at risk due to fuel limitation. With centralized data ingestion, the Uncertainty Platform also displays neighboring conditions, which combined with pattern recognition and clustering, informs risk of interchange schedules. (3) Net Uncertainty Model: utilizing the latest machine learning analytics, a net uncertainty prediction model is provided to dynamically set the operator's reserve requirements based on daily risk profiles.

The core platform capabilities realizing the probabilistic decisioning potential within the Uncertainty Platform include data storage and processing, machine learning operations, business intelligence, and system integration.

Data storage and processing is a central most capability within the Uncertainty Platform architecture, ensuring the high availability of data with polyglot persistence. The storage capability is a customized application of the medallion and lake-house architectures, consisting of zonal separations at the physical storage layer and the serving of data in raw, enhanced, and enriched states. Data processing orchestrates the migration of data from operational systems to each of these zonal separations using parametrized data pipelines with activated metadata from a centrally managed data source registry. Centrally shared services manage data in a raw and enhanced state, while individualized services and tooling are utilized within a domain context to manage data in an enriched state. Data processing can have two modalities: batch processing and stream processing. In quantifying probabilistic decisions, advanced analytical methods are applied to properly identify causality of a phenomena.

Machine learning operations receives outputs of advanced analytics and enables a containerized implementation of the analytical model. Models themselves are managed as microservices that can be coupled with a variety of technology services across the Uncertainty Platform.

Business Intelligence serves as the visualization and application layer of the Uncertainty Platform, enabling a rich user experience for operators to become informed of risk factors and make scenario-based decisions leveraging data in an enriched state.

System integration encompasses each of the information exchange protocols across the various technologies in the Uncertainty Platform, facilitated by application programming interfaces (APIs). A key component of system integration within the Uncertainty Platform is the direct exchange of decision outputs from the cloud-hosted applications to on-premises, operational systems that provide information in coordinating the management of the bulk electric system.

In an aspect, computer implemented systems and methods provide an uncertainty platform for an energy grid controller that (1) receives risk inputs including (for example) (a) one or more load forecasts, (b) one or more wind forecasts, (c) one or more solar forecasts, (d) one or more generator availability risk forecasts, (e) one or more generator fail-to-start or fail-to-run predictions, (f) one or more net scheduled interchange forecasts, and/or (g) one or more transmission congestion forecasts; (2) determines net uncertainty for a predetermined time period based on the risk inputs; and (3) provides dynamic risk outputs including forecast scenarios, reserve requirements and/or reserve margin thresholds based on the determination of net uncertainty.

In another aspect, a computer implemented platform for managing risk and uncertainty for energy grid operators, includes: a forecasting application providing probabilistic forecasts or uncertainty quantification for load, weather, and renewable-energy forecasting aspects; a risk analytics and visualization application providing availability risks of generation, fuel and net scheduled interchange and displaying at least portions of the availability risks in a geographic overlay; and a net uncertainty application dynamically setting reserve requirements based on periodic risk profiles. In a more detailed embodiment, the platform further includes a cloud-based storage architecture, that serves data to the platform in raw, enhanced and enriched states. Alternatively, or in addition, the platform further includes application programming interfaces providing exchange of communication between cloud-hosted applications of the platform and on-premises operations of the platform. Alternatively, or in addition, the forecasting application utilizes historical quantifications of net uncertainty. Alternatively, or in addition, the forecasting application utilizes an overlay of solar forecast and cloud-cover forecast to predict rapid changes in solar penetration. Alternatively, or in addition, the platform further includes an application producing dynamic commitment reserve margins. Alternatively, or in addition, the platform provides multiple deterministic forecasting models for allowing cross-validation of uncertainty predictions or understanding ranges of possible outcomes.

In another aspect, a computer implemented method for dynamically setting reserve requirements for an energy grid based on net uncertainty is provided that includes: receiving risk inputs including several (or all) of the following: (a) one or more load forecasts, (b) one or more wind forecasts, (c) one or more solar forecasts, (d) one or more generator availability risk forecasts, (e) one or more generator fail-to-start or fail-to-run predictions, (f) one or more net scheduled interchange forecasts, or (g) one or more transmission congestion forecasts; determining net uncertainty for a predetermined time period based on the risk inputs; and dynamically setting reserve requirements for an energy grid based on the determined net uncertainty. In a more detailed aspect, the net uncertainty determination utilizes a machine learning model to provide a predicted daily risk profile. In a further detailed embodiment, the machine learning model predicts high, medium or low uncertainty levels based on which normal or high reserve requirements will be set for the day-ahead and real-time markets. In a further detailed embodiment, the machine learning model includes a tree-based machine learning model and/or a deep neural network model. Alternatively or in addition, the machine learning model utilizes a feature engineering gradient model that ties multiple approaches to build a set of features to forecast net uncertainty. Alternatively, or in addition, the set of features include: lagged features; seasonality features, including indicators for daily, weekly and seasonal patterns; non-linear and interaction terms; and external regressors (where the external regressors include wind forecast, solar forecast, load forecast and/or weather forecast).

Alternatively, or in addition, the machine learning model utilizes a feature engineering in deep neural network model that incorporates regressors, autoregressive inputs and time-based features. In a more detailed embodiment, the regressors represent factors including weather conditions, load forecast and/or weather forecast. Alternatively, or in addition, the time-based features include weather-based seasonality components.

Alternatively, or in addition, the machine learning model generates a time series forecast of uncertainty in MW at a predetermined time-based granularity. In a more detailed embodiment, the time series forecast of uncertainty is translated into low, medium or high levels of uncertainty.

Alternatively, or in addition, the net uncertainty application quantifies net uncertainty as the difference between real-time and day-ahead forecast in forward reliability assessment commitment (FRAC) process.

In another aspect, a computer implemented method for operating an energy grid controller includes: receiving risk inputs including: (a) one or more load forecasts, (b) one or more wind forecasts, (c) one or more solar forecasts, (d) one or more generator availability risk forecasts, (e) one or more generator fail-to-start or fail-to-run predictions, (f) one or more net scheduled interchange forecasts, and/or (g) one or more transmission congestion forecasts; determining a net uncertainty and/or a risk forecast for a predetermined time period based on the risk inputs; and providing a graphical display comprising a geographic map overlayed with information pertaining to the determined one or more of net uncertainty or risk forecast. In a more detailed embodiment, the graphical display comprises a fail-to-start dashboard that displays a geographic map overlayed with visual fail-to-start risk information. Alternatively, or in addition, the graphical display comprises a gas pipeline dashboard that provides a visualization of a gas pipeline network that covers a geographic region of the energy grid operator with visual generation-at-risk information associated with the gas pipeline network.

In another aspect, a computer implemented method for dynamically setting commitment reserve margins for an energy grid based on net uncertainty includes: receiving risk inputs including several (or all) of: (a) one or more load forecasts, (b) one or more wind forecasts, (c) one or more solar forecasts, (d) one or more generator availability risk forecasts, (e) one or more generator fail-to-start or fail-to-run predictions, (f) one or more net scheduled interchange forecasts, or (g) one or more transmission congestion forecasts; determining net uncertainty for a predetermined time period based on the risk inputs; and dynamically setting commitment reserve margins for an energy grid based on the determined net uncertainty.

In another aspect, a computer implemented method for dynamically setting regulation requirements for an energy grid based on net uncertainty includes: receiving risk inputs including several (or all) of the following: (a) one or more load forecasts, (b) one or more wind forecasts, (c) one or more solar forecasts, (d) one or more generator availability risk forecasts, (e) one or more generator fail-to-start or fail-to-run predictions, (f) one or more net scheduled interchange forecasts, or (g) one or more transmission congestion forecasts; determining net uncertainty for a predetermined time period based on the risk inputs; and dynamically setting regulation requirements based on quantified net uncertainty.

In another aspect, a computer implemented method for dynamically setting ramp requirements for an energy grid based on net uncertainty includes: receiving risk inputs including several (or all) of the following: (a) one or more load forecasts, (b) one or more wind forecasts, (c) one or more solar forecasts, (d) one or more generator availability risk forecasts, (e) one or more generator fail-to-start or fail-to-run predictions, (f) one or more net scheduled interchange forecasts, or (g) one or more transmission congestion forecasts; determining net uncertainty for a predetermined time period based on the risk inputs; and dynamically setting ramp requirements based on quantified net uncertainty.

In another aspect, a computer implemented system for dynamically selecting or blending between two or more external forecasting vendors includes: (A) a real-time vendor switching algorithm to select between two or more vendor's forecasts based on historical performance analysis and forecast deviation thresholds; and (B) an artificial intelligence ensemble including, (1) a classification model trained to predict vendor accuracy, and (2) a gradient-based regression model trained with historical data to provide a combined output from the two or more external forecasting vendors.

These and other aspects and objects of the current disclosure will be apparent from the following description, the appended claims and the attached drawings.

### BRIEF DESCRIPTION OF THE DRAWINGS

FIG. 1 provides a block diagram representation of an Uncertainty Platform according to an embodiment;

FIG. 2 provides a system diagram representation of an Uncertainty Platform according to an embodiment;

FIG. 3 provides a block diagram representation of a layered architecture of an Uncertainty Platform according to an embodiment;

FIG. 4 provides an example geographical overlay fail-to-start risk dashboard display according to an embodiment;

FIG. 5 provides an example fail-to-start risk dashboard display according to an embodiment;

FIG. 6 provides an example geographic overlay pipeline at risk dashboard display according to an embodiment;

FIG. 7 provides a flow chart of an example process for determining at risk pipelines according to an embodiment

FIG. 8 provides an example interchange schedule risk dashboard display according to an embodiment;

FIG. 9 provides a block diagram representation of cloud-based storage and processing for an Uncertainty Platform according to an embodiment;

FIG. 10 provides a block diagram representation of a forecast system of an Uncertainty Platform according to an embodiment;

FIG. 11 provides a block diagram representation of a machine learning operations for an Uncertainty Platform according to an embodiment;

FIG. 12 provides a block diagram representation of a business intelligence application of an Uncertainty Platform according to an embodiment;

FIG. 13 provides a block diagram representing system integration within an Uncertainty Platform according to an embodiment;

FIG. 14 provides a visualization of net uncertainty in a sample day for an energy grid controller according to an embodiment;

FIG. 15 provides a graphical illustration of net uncertainty comparison between historical years for an energy grid controller according to an embodiment;

FIG. 16 provides a graph illustrating a correlation between net uncertainty for an energy grid controller and high wind or high load forecasts;

FIG. 17 provides a bar-graph visualization of uncertainty distribution at peak-load hours;

FIG. 18 provides a flow diagram representation of a process for setting dynamic short-term reserve (STR) requirements;

FIG. 19 provides a flow chart representation of an uncertainty quantification and requirement formation process for regulation reserve in an embodiment;

FIG. 20 provides bar-code representations of ramp-up uncertainty for Spring, Summer, Fall and Winter in an embodiment;

FIG. 21 provides a block diagram representation of vendor switching and combining process according to an embodiment;

FIG. 22 provides a block diagram representation of a vender switching algorithm according to an embodiment;

FIG. 23 provides an example operation forecast dashboard display for an Uncertainty Platform according to an embodiment; and

FIG. 24 provides example graphical user interfaces for an Uncertainty Platform according to an embodiment.

### DETAILED DESCRIPTION

The current disclosure provides various embodiments of an Uncertainty Platform that provides capability, flexibility and scalability to manage variability and uncertainty in large electric grids. In an embodiment, the Uncertainty Platform receives probabilistic/weather-based as well as weighted wind/solar/load scenarios, aggregate to probabilistic/weather-based as well as weighted net load scenarios, and assess overall risk assessment including generation, net scheduled interchange (NSI), and transmission related risks. The platform provides recommended/default load and renewable scenarios, but forecasters can override scenarios, and operators can choose different ones to send to downstream applications (like Capacity Sufficiency Assessment Tool and Day-Ahead and Real-Time systems). The platform hosts advanced, descriptive, predictive and prescriptive data analytics including a net uncertainty machine learning model to predict daily risk profile and enable dynamic reserves.

This disclosure provides various embodiments of a transformative tool that will fundamentally reshape grid operators' approach in response to the integration of renewable resources. This transformation involves a shift from a historical deterministic framework to a forward-looking probabilistic methodology, thereby laying the groundwork for operations over the forthcoming decades.

Embodiments of the platform include grid operator production data ingested and architected in cloud-based storage and databases; advanced computational performance through the use of artificial intelligence, machine learning, and algorithms; advanced visualization including weather geographic overlay; stochastic scenario generation synergized with an ensemble of Numerical Weather Prediction models; automated predictive analytics and stochastic operational assessment; and associated application user interfaces allowing accessibility by market/reliability members and the public.

Embodiments of the disclosed platform is built for current and future needs. To address the current and future needs the platform provides multiple components and capabilities. (1) Centralizing risk assessment inputs from multiple sources, including probabilistic weather and load forecasts, probabilistic wind & solar forecasts from multiple vendors, generator availability including gas pipeline risks, generator fail-to-start or fail-to-run prediction (based on winterization survey that the grid operator collects from Market Participants), neighboring entity conditions (such as weather, load, and renewable generation forecasts at PJM, SPP, TVA, SOCO) etc. (2) Visualizing risk assessment scenarios on individual components as well as on net impact, including uncertainty spreads of weather, load, and renewable forecasts over the next 7 days, forecasted net uncertainty, net uncertainty historical quantifications, ramping forecasts, overlay of supply vs. system obligation (load plus reserve requirement), and the overlay of solar forecast and cloud cover to aid real-time operations (so that operators in control room would know the areas with potential solar forecasting errors) to better prepare for the rapid increase of solar penetration in the next few years. (3) Analyzing risk assessment insights through several methods and techniques including: automating forecasting performance monitoring for weather forecast scenarios, load forecast scenarios, renewable forecast scenarios from multiple vendors; using advanced analytics to generate load, wind/solar forecast scenario that may be different from the “most likely” load forecast produced by vendor software or vendor forecasts, based on forecasted weather scenarios and historical uncertainty quantification; using advanced analytics to predict multi-day ahead wind/solar curtailment due to congestions; and using advanced analytics to predict the high/medium/low net uncertainty to enable dynamic reserve setting for reliable and efficient uncertainty management. (4) Utilizing risk assessment results by: allowing a grid controller's Operations Risk Assessment team and Control Room personnel to select or override any load/renewable forecasts to feed into downstream applications (including grid controller's reliability commitment processes); monitoring renewable forecasting accuracies to switch vendors in real-time, automatically; quantifying the risk levels for future operating hours/days allowing grid controller to coordinate with members on generator/transmission outages in operations planning and to make commitment decisions for long-lead units in reliability processes, and to recommend dynamic reserve requirements (e.g., Reliability Margin in grid controller's Forward Reliability Assessment Commitment processes, Short-Term Reserve product, Ramp Capability Product and Regulating Reserve) in operations and market processes.

Referring to FIG. 1, the current disclosure provides an exemplary operations Uncertainty Platform 100 for energy grid operators that receives various risk inputs; calculates and predicts aggregate uncertainty 103 from probabilistic forecasts 104, uncertainty bands calculations 106, confidence interval determinations 108, trend visualizations 110 and/or performance metrics 112; and generates risk outputs 114 including forecast scenarios, reserve requirements and/or reserve margin thresholds. The risk outputs may be used by the energy grid operators to adjust commitments and reserves 116. This may involve adjustments associated with Capacity Sufficiency Analysis Tool (CSAT), Look Ahead Commitment (LAC), Forward Reliability Commitment (FRAC) and Day-Ahead and Real-Time Markets (DA/RT).

In an embodiment, the Uncertainty Platform includes multiple important features: (A) It centralizes all risk components (including weather, wind, solar, generation, fuel, net scheduled interchange, transmission) on a single platform. While other applications with one or a few components exist, the exemplary Uncertainty Platform includes all risk components. (B) It integrates multiple customized analytical models and presents the insights to users via user interfaces on a single platform. (C) It produces operating forecast scenarios, dynamic reserve requirements and dynamic commitment reserve margins, and it feeds those results to other market and operations systems at ISOs/RTOs.

In an embodiment, NWP (numerical weather prediction)-based load forecasts are inputs to the Uncertainty Platform. Each NWP scenario is processed by load forecasting models, resulting in a load forecast scenario. And a collection of load forecast scenarios based on NWP models feed into the Uncertainty Platform for risk assessment and serve as inputs for various analytical models.

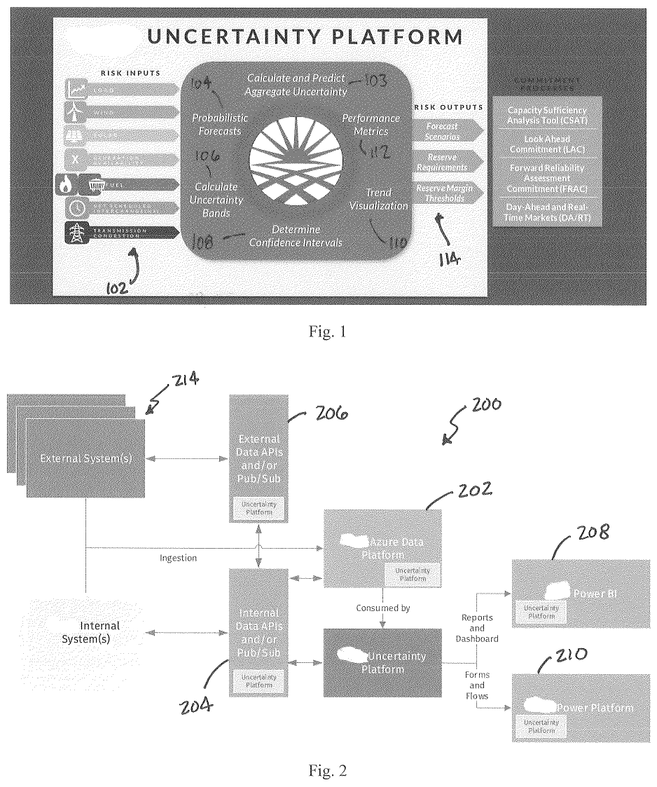

FIG. 2 provides an exemplary system diagram 200. The exemplary Uncertainty Platform 212 includes custom services to support capabilities as well as solution components that are deployed in other areas of the overall enterprise platform. These include: Ingestion catalog definitions in the Data Platform; Curation scripts in the Data Platform 202; Internal Data APIs and Pub/Sub 204; External Data APIs and Pub/Sub 206; Visualizations in the Power BI Platform 208; and Forms and Workflows in the Power Platform 210. Internal grid operator systems may interact with the Uncertainty Platform 212 via APIs and/or message pub/sub. External systems 214 may interact with the Uncertainty Platform 212 indirectly via internal APIs 204 and/or message pub/sub.

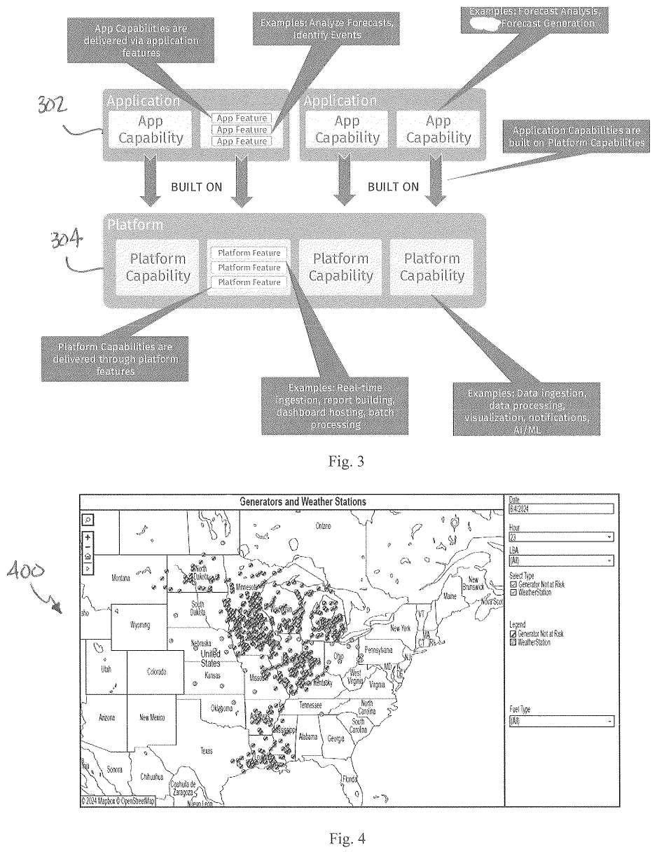

Referring to FIG. 3, an embodiment of the Uncertainty Platform is architected with two fundamental layers: an application or functionality layer 302 including (1) Probabilistic forecasts and uncertainty quantification (2) Risk analytics and visualization (3) Net uncertainty and other machine learning (ML)/artificial intelligence (AI) models; and a platform or capability layer 304, including (1) Data storage and processing, (2) Machine learning operations, (3) Business Intelligence, (4) System integration. The “platform” layer 304 provides the foundation for commercialization. ISOs/RTOs can customize their own applications.

Uncertainty Platform Business Applications. Grid operators manage a portfolio of uncertainties ranging from weather, load, wind and solar to generation and fuel availability, imports/exports with neighbors, as well as transmission congestion. The Uncertainty Platform provides control room operators and support staff centralized visualizations for situational awareness of these uncertainties that are quantified by risk analytics. The platform also hosts ML/AI models that predicts net uncertainty for dynamic reserves to manage uncertainties through markets. Additionally, it generates forecasting scenarios for the market management system to optimize unit commitment and economic dispatch.

Probabilistic Forecasts and Uncertainty Quantification. Energy grid operators and their vendors have a long history of forecasting load, wind and solar. As the grid becomes more volatile and weather dependent, multiple forecasting scenarios are established based on Numerical Weather Prediction models, including extreme scenarios such as icing, cold temperature cutoff, snow, etc. In addition, as renewable energy serves an increasing portion of the generation fleet, energy grid operators are employing multiple forecasting vendors. The Uncertainty Platform supports a centralized and architected repository of data coming from many sources and vendors. These forecasting scenarios are used to quantify uncertainties associated with the forecasts and enables scenario analysis in the operations planning processes. In addition, the Uncertainty Platform includes automatic alerts to prompt engineers and operators to pay attention to upcoming risk events, for example, when wind or solar ramps significantly, or when a large uncertainty is predicted.

Advanced Data Analytics. Embodiments focus on coordinating uncertainties from different sources and making optimal decisions in ranking and selecting the best forecast scenarios in varying situations. The significant challenges from uncertainty on congestion have not been addressed well in prior research and practice. The probabilistic scenarios combined with production level multi-day security-constrained unit commitment (SCUC) and full-scale network analysis tools to predict congestion and dispatch-down renewable is an innovative approach in addressing congestion uncertainties. This disclosure is targeted on solving the problem faced by large scale grid operator systems with significant congestion uncertainty and the large penetration of wind and solar resources. The platform makes use of high-performance computational tools with solid model-based simulation of scenarios.

Receiving the data from the external sources provides a baseline. At this point, grid controller operators perform data conditioning where required. Risk analysis is primarily based on data points captured by the Uncertainty Platform. Analysis occurs on data across regions, including load, wind, solar, net load, fuel risk, fail-to-start/run risk. Based on incoming data, the platform builds medium term load forecast (MTLF) models. The system and MTLF models identify: (1) MTLF patterns, trends, and predict likely scenarios based on incoming data; (2) data across regions and build Renewables models based on incoming data; and (3) Renewables patterns renewables and trends.

In some embodiments the system may allow modification of a load or renewables forecast based on Uncertainty Platform analysis. Other modifications/selections may include selection to receive preferred input from a primary or secondary renewable vendor.

Upon analysis, the system may produce solar dispatch down, wind dispatch down, and performance monitoring forecasts. Additionally, the system may track historical net-load uncertainty distribution.

The analysis and forecasting results in the generation of a risk aggregation dashboard which displays all analytical data for the current forecast. The risk aggregation dashboard may be viewed by a user interface and may include the displays of FIGS. 4, 6 and/or 8 as described below.

The visualizations, and customizable visualizations, the system may provide include but are not limited to: (1) customizable renewables forecasting visualizations for the next six days, including the current day; (2) 7-day solar visualizations; (3) 7-day wind visualizations; (4) customizable load forecasting visualizations for the next six days, including the current day, including: LBA-level, load pocket, sub-regional level (north, central, south) and system-wide level; (5) forecasted weather vs. historical weather forecasts for general analysis within the past hours (midnight to current time) of the current day; (6) forecasted weather vs. historical weather forecasts for specific actuals for the last two (2) calendar days; (7) “MISO analytical” MTLF, weighing differences from forecast vendors, and adjust weighting on farm-level or system-wide level; (8) “MISO offset” MTLF (offset added by forecasters/operators); (9) “MISO offset” hourly renewable forecasts (offset added by forecasters/operators); (10) scheduled NSI as well as forecasted NSI, for the current Operating day (OD) and the next 6 days, for system-wide, and for classic and south region separately; (11) wind and solar gradient forecasts and gradient spread; (12) wind and solar ramp forecasts from all vendors, in a comparative view; (13) wind and solar ramp forecasts for system-wide and sub-regional level forecasts; (14) wind and solar dispatch down, including actual dispatch down for past hours of the day, and forecasted dispatch down for rest of the day and for the next 1-2 days; (15) net load and net load uncertainty; (16) actual net load for past hours of current day, forecasted net load scenarios and uncertainty for rest of the day and the next 6-days; (17) historical net load uncertainties at day-ahead, 8-hours ahead, 4-hours ahead, 30-min ahead intervals; (18) forecasting “performance” monitoring of each forecast vendor weather performance, for the past few days and on system-wide level, and sub-regional level; (19) forecasting “performance” monitoring of MTLF, for each weather scenario, for the past few days, for different Itron models, and on the system-wide level, sub-regional level, LBA level and load pocket level; (20) forecasting “performance” monitoring of STLF forecasting performance on system-wide level, sub-regional level and LBA level, on 10-min ahead, 30-min ahead, 1-h ahead, 2-h ahead, 3-h ahead intervals, and for the past few days and past hours of current day; (21) forecasting “performance” monitoring of renewable forecasting performance, for all forecast vendors, for the past few days and for the past few hours, for day-ahead, 4-h ahead and 8-h ahead for hourly forecasts intervals, and for 10-min ahead, 30-min ahead, 1-h ahead, 2-h ahead, 3-h ahead for 5-min forecasts; (22) gas pipeline risks; (23) coal fuel risks; (24) fail-to-start and fail-to-run risks; (25) solar and cloud coverage overlay; (26) supply vs obligation; (27) aggregated risk prediction; (28) short-term reserve (STR) requirements and default recommendation; (29) neighboring entity conditions such as temperatures, renewables, and load forecasts.

Furthermore, some embodiments may allow users to access sub-regional level (north, central, south) and unit level forecasting visualizations. The system and its interfaces may provide separate visualization views for system-wide level and the sub-regional level. Additional embodiments may allow users to generate visualizations with the option to include or exclude NSI in “net load” calculation.

Risk Analytics and Visualization. Availability risk of generation, fuel and imports/exports are historical unknowns. However, as evidenced from multiple extreme cold weather events such as Winter Storm Elliot, uncertainties from these subjects can introduce significant operating challenges. Risk analytics and visualization are developed for the Uncertainty Platform to provide operators situational awareness and support their decision making. Through the collaborative efforts with its members, grid operators administer an annual generator winterization survey that collects important information including generators' cold temperature cutoffs, pipeline information of contract firmness, and other pipeline services subscribed to.

FIG. 4, for example, provides an example “Fail to Start Risk” dashboard 400 as provided by an embodiment of the Uncertainty Platform. As shown in FIG. 4, a weather geographic overlay of the thermal generation fleet and temperature forecast is built to assess generator fail to start risk during extreme cold weather if the forecasted temperature falls below the cold temperature cutoffs. The fail-to-start risk calculation relies on multiple inputs: Winter survey submitted by Market Participants to ISOs/RTOs with the information of temperature thresholds below which the generators would likely fail to start; Hourly temperature forecasts across 50-300 weather stations; Unit commitment (which generators are scheduled to be online and for what period); and Generator offers submitted by Market Participants to ISOs/RTOs, indicating whether the risk of generators fail-to-start due to low temperatures is already captured by Market Participants. In the display of FIG. 4, a first type of symbol or color overlay (overlayed over the map) may indicate generators not-at-risk, while a second type of symbol or color overlay may indicate generators at-risk.

An example calculation of generators at risk for failing to start is as follows. The results would be “X GW generation is at risk to start at Y region for HEXX on Operating Day DD/YYYY”. ISO/RTO would then incorporate this risk for its operations planning and take actions such as committing long-lead generators, committing a unit ahead of time with higher-than-threshold temperature, or rescheduling certain planned generation/transmission outages. Step 1. Graph the weather forecasts from all weather stations for the next 168 hours. Step 2. For each generator and for each hour, assign temperature from its closest weather station if the distance is within a threshold. Otherwise, a linearly interpolated temperature is calculated from a few weather stations. Step 3. Designate the capacity of a generator to “at risk” if the forecasted temperature is below its threshold submitted in winter survey, unless the generator is already online, will be online ahead of the target hour, or is on outage. Step 4. Calculate the total generation GW at risk per region, per fuel type and per lead-time.

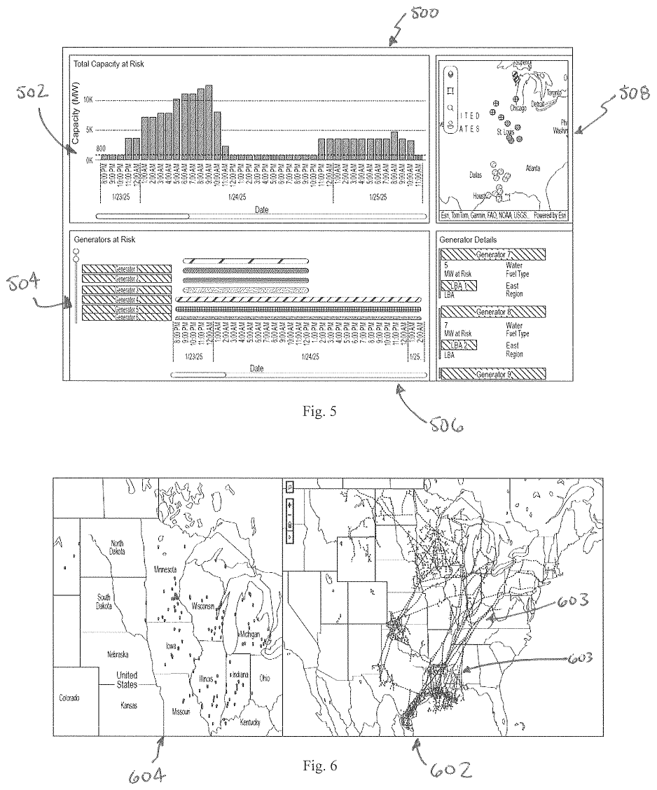

FIG. 5 provides an example “Generator Fail to Start Dashboard” main page 500. On the visualization, the top left is total generation GW “at risk” for each hour for the next 168 hours 502; bottom left is the list of generator names “at risk” 504; Geographic visualizations (sizes representing generator capacity, and colors representing different regions) and generator details are in the middle 506. The right of the dashboard provides options for users to choose different regions, fuel types, locations etc. to produce a more focused risk assessment 508.

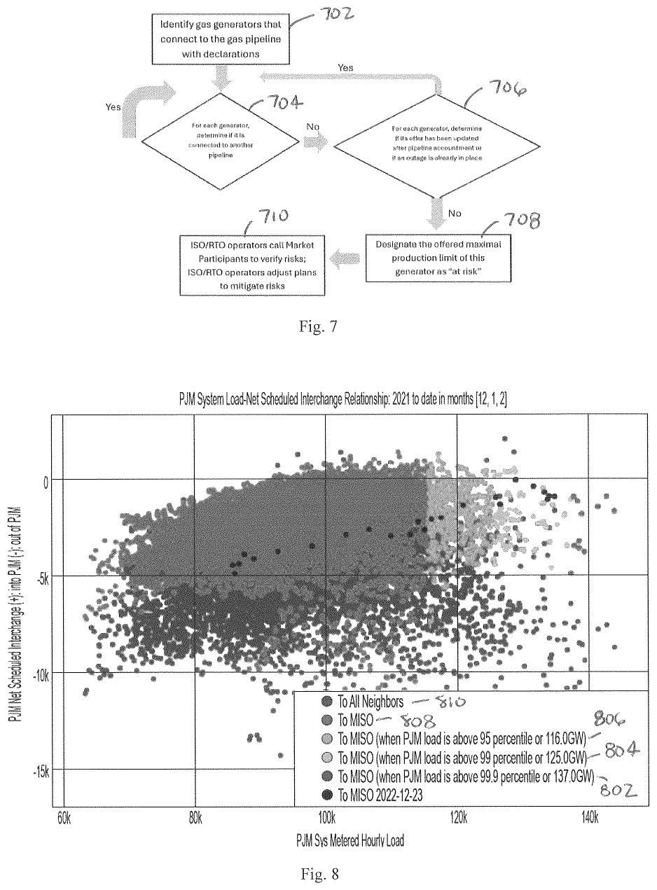

As shown in FIG. 6, an example dashboard 600 providing an overlay of the gas generation fleet and gas pipelines is also built to quantify generation capacity at risk due to fuel limitations. The energy grid operator coordinates and monitors any gas pipeline critical notices. If a pipeline has critical notices, units relying on that pipeline and the corresponding generation capacity at risk may be identified by cross checking their contract firmness, especially for those that have interruptible transportation. The Gas Pipeline dashboard includes a visualization of the gas pipeline network that covers the entire grid-operator's footprint (right) 602 as well as gas generator locations (left) 604. The underlying data also captures which generators are connected to which gas pipelines. When there is a declaration of gas pipeline interruptions (due to weather, mechanic issue, etc.), the risk quantification of its impact on gas generator availability is calculated as shown in FIG. 7. The results would be “X GW gas generation at risk” at certain geographic locations, and ISO/RTO operators would use that information to contact Market Participants to verify risks and to adjust ISO/RTO's operations plans. In the display 602, visual representations of pipelines 603, may be overlayed on a geographical map where pipelines 603 shown in a first color (e.g., green), pattern or intensity (for example) may indicate pipelines with no interruption risk or outage while pipelines 603 shown in a second color (e.g., red), pattern or intensity (for example) may indicate pipelines with an interruption risk or an outage.

Referring to FIG. 7, in step 702, identify gas generators that connect to the gas pipeline with declarations. In step 704, for each generator determine if it is connected to another pipeline. If yes, then repeat step 704 for the next generator; but if no, proceed to step 706. In 706, determine if that generator, determine if its offer has been updated after pipeline accountment or if an outage is already in place. If yes, then repeat step 704 for the next generator; but if no, proceed to step 708. In step 708, designate the offered maximal production limit of this generator “at risk.” Thereafter in Step 710, grid operators may contact Market Participants to very risks and grid operators may adjust plans to mitigate the identified risks.

With centralized data ingestion, the Uncertainty Platform provides situational awareness of neighboring conditions. The forecasted neighboring conditions, combined with historical pattern recognition and clustering, informs risk of interchange schedules. As shown in FIG. 8, an example dashboard 800 for displaying interchange schedule risks based on historical load pattern is provided.

The visualization of historical Net Scheduled Interchange (NSI) between a neighboring grid (PJM) and a controller's grid (MISO) is used as analytical tool for the grid controller to assess the range of uncertainty related to distribution of energy between PJM and MISO, particularly for an expected tight system condition. Because PJM's capability of distributing energy to MISO depends on its own system condition, this historical Net Scheduled Interchange (NSI) chart visualizes the NSI between PJM and MISO into four groups with different colors. FIG. 8 is an example visualization using summer months (June, July and August): yellow dots 802 indicate the distribution of NSI between PJM and MISO when PJM's load is over 99.9 percentile or 149 GW; red dots 804 indicates PJM's load is over 99 percentile or 143 GW; orange dots 806 indicates PJM's load is over 95 percentile or 134 GW; and green dots 808 represent all historical NSIs from PJM to MISO; blue dots 810 represent all historical NSIs from PJM (to MISO or others). This visualization can be modified to present different season as well as including specific historical market day that PJM had experienced high load.

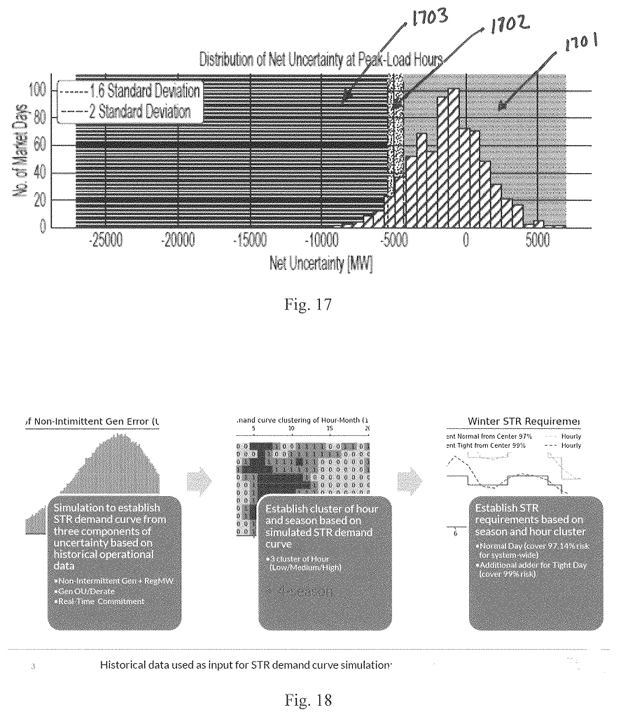

Appropriately setting the reserve requirements achieving both the reliability objective while maintaining economic efficiency pose several challenges given the complicated underlying uncertainty factors and their correlation. An embodiment provides a next-day net uncertainty model that dynamically sets the requirement for its Short-Term Reserve (STR) product based on the ML model predicted daily risk profile. The model first quantifies the net uncertainty in the targeted operating timeframe constituted from load, wind, solar, generation derates/forced outages and imports/exports. A Gradient Boosted uncertainty prediction ML model is established to predict High/Medium/Low uncertainty levels, based on which Normal/High reserve requirements will be set for the Day-Ahead and Real-Time markets (as shown in FIG. 17 and Table 1). The net uncertainty model is established for both systemwide and sub-regional levels so that adequate reserves may be cleared and delivered for each sub-region.

TABLE 1

| | Commitment | Short-Term |
|---|---|---|
| Net Uncertainty Forecast | Threshold | Reserve Requirement |
| LOW (Green Zone) | Low | Normal |
| MEDIUM (Yellow Zone) | Medium | |
| HIGH (Red Zone) | High | Emergency |

Embodiments of the Uncertainty Platform automate the full cycle of the dynamic reserve process, including data ingestion, ML model operation, user interface visualization and system integration with the downstream Market Management System through APIs. The Uncertainty Platform architecture supports extendibility as grid needs continue to evolve in the Operations of the Future. Multiple ML/AI models may be utilized for the Uncertainty Platform, including (1) an Intra-Day Net Uncertainty Model for dynamic regulation and ramp capability product; (2) an online decision-making algorithm based on reinforcement learning to automatically and timely switch to the better-performing vendor forecasts; and (3) a deep learning approach to optimally and dynamically assemble different forecasting scenarios based on conditional historical performance and real-time trending.

Technology Capabilities. In a cloud-centric enterprise data platform embodiment that includes the Uncertainty Platform, data domains act as the semantic and logical organizing patterns for serving centrally shared data, provisioning application services, enforcing standards, building shared system integrations, protecting information, and applying security controls. Data domains are derived from an enterprise capability model and provide the bounded contexts for domain-driven design practices. The domain-driven data management practice provides the Uncertainty Platform with the relevant data to build business applications, quantify uncertainty, and visualize risk. Beyond the systemic challenges of enterprise data management, the Uncertainty Platform enables operational decisions through the core technical capabilities of data storage and processing, machine learning operations, business intelligence, and system integration.

Data Storage and Processing. An embodiment of the Uncertainty Platform utilizes cloud-based technology intended to store, transform, and transport data continuously to reliably support probabilistic operational decisions. The ability to store and serve data of virtually any format from operational systems is realized by medallion and data lake-house architectures. As shown in FIG. 9, the medallion architecture includes three blob storage containers or zones named bronze 910, silver 912, and gold 914. The bronze zone 910 is where data is first ingested into the cloud ecosystem with limited processing, representing an immutable and time organized historical archive. The silver zone 912 contains data that has been validated, cleansed, and given standardized structure from the bronze zone, typically in the form of an open table format. Open table formats enable a persistence of state and atomicity for the stored data. The gold zone 914 contains data that has direct production value with little to no modification to the persisted data structure; they are decision ready and built for purpose products. The data lake-house 916 is a logical data warehouse where data is referenced from the gold zone 914 and can be materialized using cloud-hosted serverless compute. The data lake-house 916 provides a query optimized reference to data in the data lake for the business intelligence layer of the Uncertainty Platform. Data processing in the Uncertainty Platform is split into two perspectives, data ingestion and data curation. Data ingestion in the Uncertainty Platform leverages data source and control parametrization to migrate data from operator-hosted sources into the zonal storage of the data lake. Data curation creates data in the gold zone and data lake-house 916 representations where the degree of parametrization is dependent on the use-case. The Uncertainty Platform supports batch and event-based processing modalities for both data ingestion and data curation where the underlying compute resources are decoupled from the storage medium.

Cloud-based Data Ingestion and Storage (Forecast Storage Database). The large-scale ingestion of operations data into a storage environment by an energy grid controller comprises a large volume and includes data from different vendors, in different formats and updated at different frequencies. The disclosed Uncertainty Platform is used for risk assessment in a control room for the grid controller, so the data ingestion and visualization need to be highly responsive, reliable, and available.

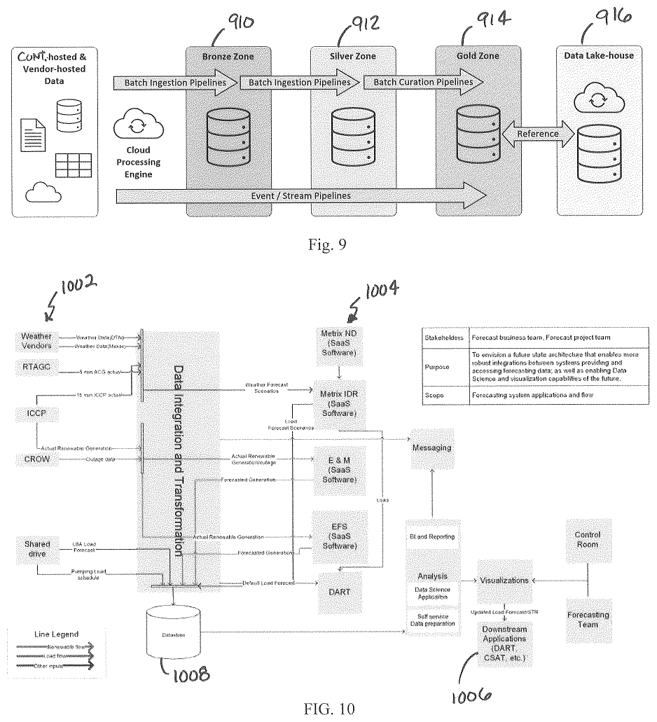

FIG. 10 provides an exemplary forecast system overview. In the diagram, the left side 1002 shows entities that provide this data, whereas the third column (beginning with Metrix ND) 1004 shows the various tools used by the Operations Uncertainty Assessment (ORA) team to provide modifications as needed based on circumstance, trends, and historical analysis. Once the forecast is complete, it will be pushed downstream to several services 1006: CSAT (capacity sufficiency analysis tool), LAC (look ahead commitment), and FRAC (forward reliability assessment commitment), as well as the DART (day ahead real time) database. The Uncertainty Platform requires a wide range of inputs from other internal systems and from external vendors. Before the ORA team uses the Uncertainty Platform to condition the data, all the sources may be combined within the forecast storage database (FSD) 1008 as a holding area for the data. The FSD is a storage location that could be on-premises, Azure-cloud, or anywhere as needed by the design. Once the ORA team has conditioned the data and prepared it for downstream use, it is exported to four primary sources within the controller's network: the CSAT, the LAC, the FRAC, and the DART database.

As part of the ingestion process, the platform may: (a) refresh any forecast data: (1) when new data is available; (2) at least every 15 minutes; (b) have a centralized database with synchronized data structures which will store data, including data from vendors; (c) retrieve data including: (1) weather scenarios for the current day and the next six days; (2) 5-minute load forecast for the LBA level; (3) 5-minute load forecast for the sub-regional level; (4) 5-minute system-wide load forecast that originated from forecasting software; (5) hourly system-wide level load forecast that originated from the forecasting software; (6) hourly load forecast on load pockets that originated from forecasting software; (7) hourly load forecast for the LBA level that originated from the forecasting software; (8) hourly load forecast for the sub-regional level that originated from the forecasting software; (9) actual wind data for past hours of the current day, on unit level from ICCP; (10) actual solar data current values, on the unit level that originated from ICCP and shall access the actual data received for historic reference; (11) scheduled NSI on system-wide level; (12) scheduled NSI on sub-regional level; (13) NSI pattern/range on system-wide level; (14) NSI pattern/range on sub-regional level; (15) solar and cloud overlay data from secondary renewable forecast vendor(s); (16) gas pipeline data that originated from the designated source; (17) unit fail-to-start data that originated from the designated source; (18) unit fail-to-run data that originated from the designated source; (19) coal inventory data that originated from the designated source; (20) generator offers that originated from DART; (21) temperature forecasts from neighboring entities; (22) renewable forecasts from neighboring entities; (23) load forecasts from neighboring entities; (24) actual load of the load pocket for the past hours of the current day that originated from ICCP; (25) actual load of the LBA level that originated from AGC; (26) actual load of the system-wide area for the past hours of the current day that originated from ICCP; (27) actual hours of the sub-regional area for the past hours of the current day that originated from ICCP; (28) 5-min wind and solar forecasts that originated from the primary renewable forecast vendor for the next 6-8 hours on unit level; (29) 5-min wind and solar forecasts that originated from the secondary renewable forecast vendor for the next 6-8 hours on unit level; (30) hourly wind and solar forecasts that originated from the primary renewable vendor for the past hours of the current day and for the next six days for current forecast (weighted average) (deterministic); (31) hourly wind and solar forecasts the originated from the primary renewable vendor for the past hours of the current day and for the next six days for each NWP Weather Model (Weighted) and raw scenarios from the primary renewable forecast vendor; (32) hourly wind and solar forecasts that originated from the secondary renewable vendor for the past hours of the current day and for the six days on the unit level for the current forecast (weighted average) (deterministic); and (33) hourly wind and solar forecasts that originated from the secondary renewable vendor for the past hours of the current day and for the six days on the unit level for each NWP Weather Model (weighted) and raw scenarios from the primary renewable forecast vendor; (d) maintain and have access to an archive of all forecasting data (input), actual data (input) and analytical results (processed by this Uncertainty Platform) for three years; and (e) have access to all live forecasting data (input), actual data (input) and analytical results (processed by this Uncertainty Platform) for three months.

Machine Learning Operations. Machine learning operations in certain embodiments of the Uncertainty Platform is a process that combines the practice of data science and software development to continuously train, manage, serve, and monitor analytical models across cloud and on-premises technology systems. Referring to FIG. 11, Machine learning operations in the Uncertainty Platform follow a practice including: model experimentation 1102, training operationalization 1104, model registration 1106, model serving 1108, and model monitoring 1110.

Model experimentation 1102 utilizes cloud-hosted data processing engines and commercially available experiment tracking systems to run, store, and analyze the information generated from conducting hypotheses tests, feature engineering, and algorithm tuning that explain an operational phenomenon. Training operationalization 1104 utilizes an operator-hosted software development platform to convert the desired model configuration and data transformations into a model training pipeline containing a series of components. Each component has defined inputs, outputs, functions, software dependencies, specified compute, and a declaration of purpose. Training pipelines are run in a cloud-hosted data processing engine via a scheduled or triggered event. Model registration 1106 in the Uncertainty Platform is the method in which a cloud-hosted service provides an interface for storing, versioning, tagging, and referencing the software and component artifacts critical to training and serving analytical models. The model registry stores the useable model objects while the software development platform manages the continuous integration and continuous deployment workflows that create and move model objects.

Model serving 1108 is the model deployment process within the Uncertainty Platform where artifacts are retrieved from a model registry, containerized, then mounted on a dedicated or serverless compute instance to build an API accessible micro-service. Traffic-allocation methods and configuration changes are utilized to update new models for online and batch serving patterns. Model monitoring 1110 in the Uncertainty Platform has two aspects: infrastructure monitoring and performance monitoring. Infrastructure monitoring leverages cloud-hosted logging services to continuously gather telemetry from compute services utilized in training and serving the model. Metrics such as request latency, usage, down-time, and cost are monitored to ensure the technical health of the model service. Performance monitoring utilizes custom defined processes with cloud hosted data-processing engines to centralize metrics associated with model training data, serving data, and model objective performance. Performance monitoring ensures the decision health of the model service.

The Uncertainty Platform may make use of artificial intelligence and/or machine learning capabilities to calculate and aggregate uncertainty, monitor performance and utilization data, perform trend visualization, determine confidence intervals, calculate uncertainty bands, and generate probabilistic forecasts. Inputs inserted/utilized to train and facilitate the artificial intelligence and machine learning include load, wind, generation availability, solar, fuel, net scheduled interchange, and transmission interchange. In addition to the outputs previously outlined the platform would generate risk outputs including stochastic operating scenarios, dynamic reserve requirements, dynamic reserve margin threshold.

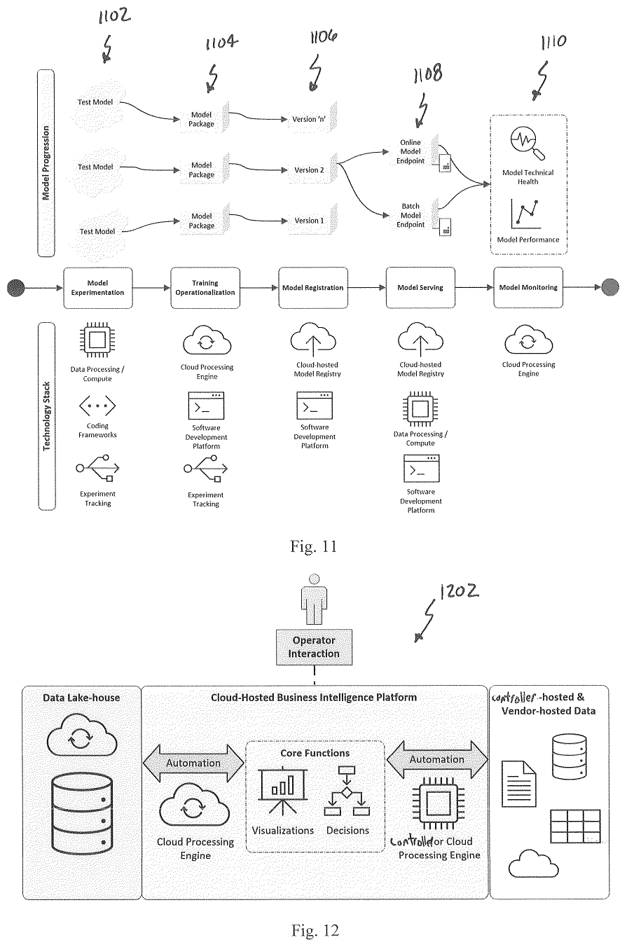

Business Intelligence. Business Intelligence forms the consumption layer of certain embodiments of the Uncertainty Platform. Referring to FIG. 12, the cloud-hosted business intelligence platform 1202 enables data from cloud-hosted and operator-hosted sources to be visualized and dynamically interacted with from an application interface. Data models are created within the Business Intelligence component of the Uncertainty Platform to enable the efficient querying of information in the cloud-hosted data lake-house. The Uncertainty Platform utilizes bi-directional integrations to translate decisions made by a consumer into useable data for transactional and analytical processes. The integrations are built using a combination of cloud-hosted and operator-hosted services to ensure the secure and reliable transport of decision-ready data into dependent information systems. Visualizations within the Uncertainty Platform are built utilizing the native functionality of the business intelligence platform and extensions.

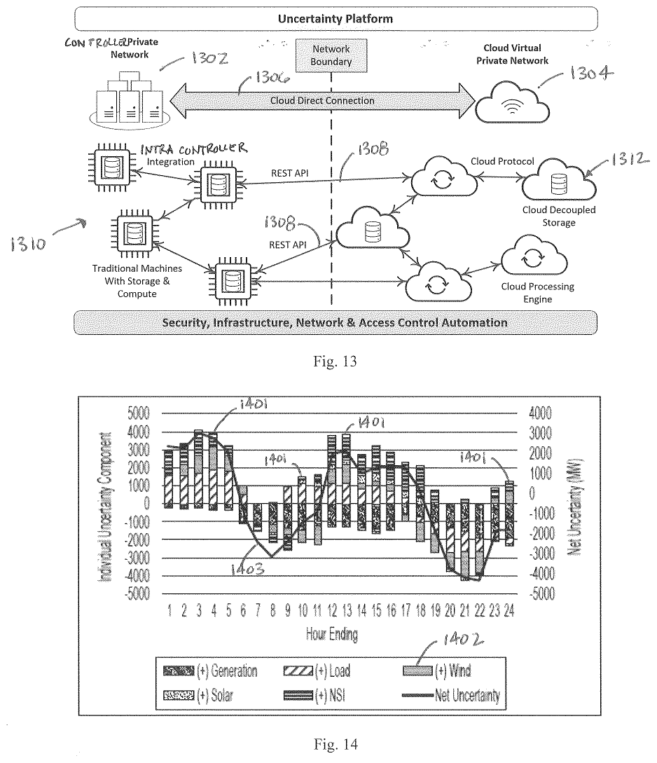

System Integration. In an embodiment, the Uncertainty Platform's domain-driven design requires interoperability between the operator-hosted and cloud-hosted services in a secure, efficient manner. Referring to FIG. 13, the Uncertainty Platform leverages a direct connection 1306 from operator-hosted private network 1302 to the cloud-service provider's virtual private network 1304. The direct connection 1306 bypasses internet service providers in the network path and offers the reliability, security, and latencies required of operational use-cases. The Uncertainty Platform relies on the cloud-provider's protocol for information exchange between cloud-hosted services and utilizes a representational state transfer architecture (REST) 1308 for the communication between operator-hosted 1310 and cloud-hosted services 1312. Interfacing with the Uncertainty Platform is enabled by both pull and push methods.

Forecasting Net Uncertainty. Embodiments may use one of two families of machine learning and forecasting models with their special characteristics to fit forecasting models, including tree-based models and deep neural networks like NeuralProphet. Each model has their strengths and weaknesses, and the choice of model may be guided by the specific characteristics of the forecasting task. Embodiments also translate the quantitative net uncertainty forecast (in megawatt) into qualitative uncertainty levels (LOW/MEDIUM/HIGH) and dynamically set the unit commitment threshold and short-term reserve requirement accordingly based on the forecasted uncertainty level or risk profile. The operations planning, unit commitment (UC) and dispatch process faces complex uncertainties from multiple sources, including but not limited to variability in electricity demand, fluctuating renewable energy generation (such as wind and solar), generation equipment failures and inherent complexities like emissions constraints. This uncertainty forecast enables the capability the assess the aggregated uncertainty from all sources and makes recommendation of needed actions throughout the market operation process. Net uncertainty forecast and dynamic reserve process may help to provide data-driven situational awareness and enhance the efficiency of unit commitment and market pricing as grid operators may increase the requirement of reserve based on forecasted high uncertainty. Furthermore, the benefit of having multiple deterministic forecast models may allow grid operators to cross-validate uncertainty predictions and better understand the range of possible outcomes. The complementary strengths of both uncertainty forecasting models have the potential to minimize forecast errors when analyzed together, offering a more reliable forecast compared to relying on a single model.

The net uncertainty represents an assessment of the aggregation of individual uncertainty components, which may either cancel out or amplify with each other in any given hour in an operating day. The assessment and forecast of net uncertainty provide valuable information that may enable grid operators to make informed decision particularly for unit commitment in prior operating day. If needed, the net uncertainty forecast can also expand for multi-day risk assessment processes to address anticipated uncertainty or risk during well forecast extreme weather events (such as extreme cold or hot weather events).

Quantification of Net Uncertainty. For any grid operation, uncertainty is continuously being assessed from multi-day ahead to near real-time. To meet a grid operator system's current operating characteristic and needs to pre-position long-lead generation resource, in an embodiment, net uncertainty is quantified as the difference between real-time and day-ahead forecast in FRAC process (Eq. 1).

$$Net Uncertainty = Δ Generation - Δ Load + Δ Wind + Δ Solar + Δ N S I - StrandedMW , \qquad ( Eq . 1 )$$

$$where Δ = Actual - Forecast at FRAC$$

For ΔGeneration, this term tracks the change in “available non-intermittent generation capacity” or the availability of conventional thermal generation, which could be negative if generation resources are experiencing rapid forced outage between day-ahead and real-time, or positive if generation resources comeback online earlier than expected or originally scheduled. The next three terms, ΔLoad, ΔWind and ΔSolar, quantify the uncertainty from forecast error of load, wind and solar generation. The sign before the ΔLoad is negative because over-forecast of load (e.g. actual load came in lower) would “help” or contribute to the net uncertainty. The term ΔNSI quantifies the uncertainty of the grid operator's Net Scheduled Interchange (NSI) with neighboring grid operators. The NSI uncertainty may be specifically crucial while the majority of the geographic regions are under the same wave of extreme weather condition. Lastly, StrandedMW is the generation MW unavailable for meeting load due to transmission constraint. By including this term, the model is forecasting transmission congestion in the net uncertainty forecast process.

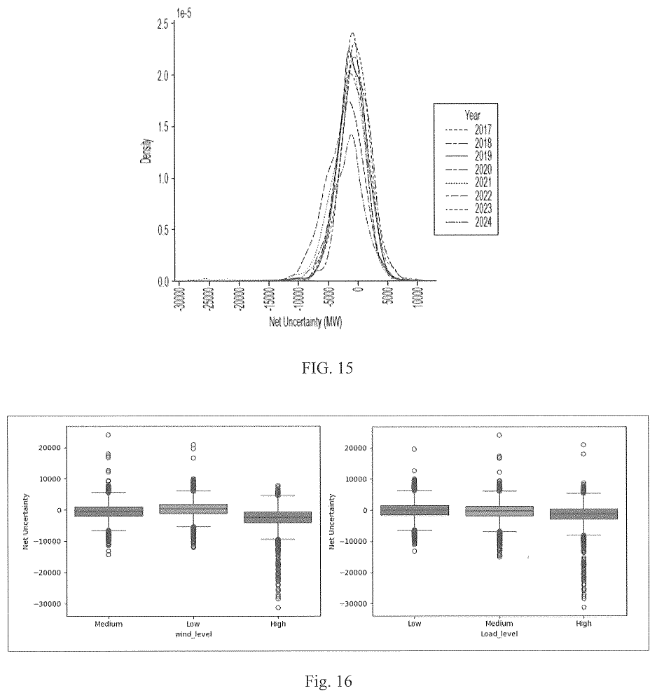

FIG. 14 illustrates the quantification of net uncertainty in a sample day, providing some interesting observations. Each stacked bar 1401 represents materialized “uncertainty” from each of the drivers. For example, bar section 1402 is the materialized wind uncertainty, calculated by using actual wind minus wind forecast. Line 1403 is the sum of the uncertainties from all drivers, or the “net uncertainty.” First, an individual uncertainty component may flip the direction of its uncertainty contribution from positive to negative in a day (or vice versa). Using wind as an example, in early morning actual wind is detected to come in higher than the wind forecast, rendering a positive wind uncertainty in the chart. However, the sensed wind comes in lower than the forecast in the afternoon and the resulting wind uncertainty becomes negative in the chart. Second, individual uncertainty components may either cancel out or amplify with each other in any operating hour. For instance, in this sample day, load, generation availability and wind coincidentally contribute to negative uncertainty in the evening hours and the net uncertainty rapidly changes from positive to negative.

Once the next-day net uncertainty is quantified, FIG. 15 and Table 2 illustrate the distribution and summary statistics of the net uncertainty retroactively calculated from year 2017 thru August 2024. Overall, the distribution of net uncertainty does not differ sharply across years except the extreme conditions that result in long left-tail. For the data period presented, the largest negative net uncertainty occurred in year 2022 during Winter Storm Elliot. The variation of net uncertainty measured by standard deviation has increased over the years especially in year 2022 and then stabilized in subsequent years. This increase in the variation of net uncertainty is correlated with change in energy grid operators' system installed wind generation capacity.

TABLE 2
Summary Statistics of Systemwide Net Uncertainty by Year

| Year | Mean | Std | Min. | 25% | 50% | 75% | Max |
|---|---|---|---|---|---|---|---|
| 2017 | −496 | 2,245 | −7,331 | −1,957 | −364 | 1,096 | 6,729 |
| 2018 | −1,116 | 2,348 | −10,322 | −2,613 | −930 | 377 | 6,001 |
| 2019 | −855 | 2,318 | −9,857 | −2,190 | −887 | 737 | 5,194 |
| 2020 | −132 | 2,394 | −7,497 | −1,680 | −161 | 1,450 | 8,758 |
| 2021 | −1,556 | 2,717 | −11,118 | −3,169 | −1,240 | 214 | 8,056 |
| 2022 | −2,391 | 3,356 | −25,576 | −4,532 | −2,001 | −192 | 5,637 |
| 2023 | −756 | 2,481 | −7,220 | −2,361 | −834 | 959 | 6,256 |
| 2024 | −1,577 | 2,648 | −11,623 | −3,284 | −1,378 | −4 | 6,969 |

In Table 3, a summary statistics of key component or explanatory drivers of net uncertainty is provided. The most significant explanatory variables to the overall net uncertainty are load forecast error, uncertainty of generation availability and wind forecast error. It is also expected the solar forecast error may become more important as energy grid operators experience rapid increase of solar generation in the system. Moreover, exploratory data analytics (EDA) also suggests net uncertainty is typically correlated with high wind or high load forecast as shown in FIG. 16.

TABLE 3
Summary Statistics of Key Component
of MISO Systemwide Net Uncertainty

| | Mean | Std |
|---|---|---|
| Net Uncertainty | −1,088 | 2,666 |
| Load Forecast Error | −276 | 1,649 |
| Generation Availability | −647 | 1,252 |
| Uncertainty | | |
| Wind Forecast Error | 268 | 1,378 |

Leveraging AI/ML for the Net Uncertainty Forecast Model. Prior to the current disclosure, grid operators maintained a fixed sufficiency margin target in the FRAC process, which may have led to unneeded unit commitments from time to time. Embodiments of the Uncertainty Platform disclosed herein and an exemplary implementation of the net uncertainty forecast enables grid operators to assess aggregated uncertainty that may lead different need of sufficiency margin, followed by improvements to the efficiency of the subsequent unit commitment process accordingly.

To forecast Net Uncertainty for the next operational day, an embodiment approaches this challenge as a time series forecasting problem, utilizing Artificial Intelligence (AI) and Machine Learning (ML). Specifically for the net uncertainty forecast task, two example model families may be utilized: Tree-based models, such as Gradient Boosting Machines (GBM), and Deep Neural Networks.

Tree-based models, including GBM, are popular in time series forecasting due to their interpretability and robustness against overfitting. These models can handle a wide range of feature types, including lagged values, seasonality indicators, and external regressors. However, they have potential limitations, such as a lack of temporal context and sensitivity to hyperparameter tuning. To address these challenges, an embodiment utilizes deep neural networks, particularly NeuralProphet method.

NeuralProphet combines the strengths of traditional time series models, like Prophet, with deep learning, making it adaptable to various time series patterns. It effectively incorporates factors like holidays, seasonality, and events, which are crucial in power system forecasting, while also reducing the need for extensive manual feature engineering by automatically capturing trends and seasonality. Neural network models require large datasets to train effectively. In an example implementation, the availability of six years of historical net uncertainty data enabled the application of these advanced forecasting models successfully.

Feature Engineering. Feature engineering may play a critical role in enhancing the performance of machine learning models for time series forecasting. In the context of net uncertainty forecast, selecting and engineering relevant features can significantly improve model accuracy.

Feature Engineering Gradient Boosting (Tree-Based) Models. To allow the Gradient Boosting model to capture the underlying patterns and relationships within the data more effectively, embodiments tie multiple approaches together to build up the set of features to forecast the net uncertainty, including: (1) Lagged Features: Incorporating lagged values of the target variable and regressors may help capture temporal dependencies. (2) Seasonality: Including indicators for daily, weekly, and seasonal patterns may improve the model's ability to capture recurring trends. (3) Non-linear and interaction terms: Combining multiple features to create interaction terms may help the model learn complex relationships between variables. (4) External Regressors: Incorporating relevant external features, which are additional features beyond the primary time series data, may significantly improve the model's ability to predict future values by providing additional context. Example external regressors: Wind Forecast: Wind generation is highly variable, and its accurate prediction may be important for reliable net load forecasting; Solar Forecast: Solar power generation depends on factors like cloud cover and sunlight hours, making solar forecasts important for predicting net load; Load Forecast: Predicting the overall electricity demand may be fundamental to accurate net load forecasts; and Weather Forecast: Components such as wind speed, solar radiation, and temperature affect both load (e.g., heating and cooling demand) and renewable generation, making it an important feature.

Feature Engineering in Deep Neural Network Model: NeuralProphet extends the classical Prophet model by incorporating advanced features from neural networks. This allows it to handle complex patterns in time series data more effectively. (1) Contextual and Regressors: In an exemplary NeuralProphet model some external regressors are included, which are additional features beyond the primary time series data. These regressors can represent factors like weather conditions, load forecast, and renewable (wind, solar) forecast. (2) Autoregressive Inputs: In this exemplary model the autoregressive terms are included to allow the model to use past values of the time series as predictors. By incorporating these lagged features, the model can capture the momentum and inertia in the data, which are crucial for accurate short-term forecasting. (3) Time-Based Features: NeuralProphet's built-in seasonality components benefit from feature engineering by specifying different types of seasonality. However, an embodiment has defined custom seasonality which may be an actual weather-based seasonality for four seasons of Spring, Summer, Fall and Winter.

The net uncertainty forecast models may generate a time series forecast of uncertainty in MW at hourly granularly. Depending on the length of the External Regressors that feed into the forecast models, embodiments can have up to 168 hours of uncertainty forecast as that's the typical forward-looking horizon for load and renewable. The next section discusses how embodiments derive dynamic commitment threshold and short-term reserve requirement based on the results of uncertainty forecast.

Uncertainty Forecast and Dynamic Reserve. An embodiment of the net uncertainty model as discussed above generates a time series of quantitative uncertainty forecast in MW. This section discusses an embodiment that translates the quantitative net uncertainty forecast MW values into qualitative uncertainty forecast labels, e.g. LOW/MEDIUM/HIGH uncertainty for the upcoming operating day. An embodiment establishes the following convention and thresholds for setting uncertainty levels: the embodiment compares the forecasted net uncertainty (MW) in peak load hour against distribution of historical materialized net uncertainty. If the net uncertainty forecast falls above 1.6 standard deviation (1.6σ) of the left-tail of historical distribution, the embodiment translates it as a LOW uncertainty day. Having net uncertainty forecast between 1.6σ and 2σ, the next operating day is given a MEDIUM uncertainty label, and lastly a HIGH uncertainty day is tagged when the forecasted uncertainty is above 2σ. FIG. 17 visualizes the distribution of materialized net uncertainty, the thresholds, and color-codes LOW/MEDIUM/HIGH uncertainty as zones 1701, 1702 and 1703 respectively.

Once the embodiment has converted the quantitative net uncertainty forecast (in MW) into qualitative uncertainty labels (LOW/MEDIUM/HIGH), the grid controller may then set the commitment threshold and short-term reserve requirement accordingly for the next operating day as illustrated in Table 4 below. The design of this dynamic commitment threshold and short-term reserve based on uncertainty forecast is similar to purchasing insurance. If the embodiment foresees a higher uncertainty, the grid controller purchases a higher insurance coverage, e.g. higher commitment threshold and reserve requirement for hedging the forecasted higher uncertainty, and vice versa. Nonetheless, an embodiment does not hedge against infinite risk and when having HIGH uncertainty forecast, the embodiment sets the commitment threshold to cover up to 2.6σ of uncertainty or 99% risk coverage.

TABLE 4
Relationship between Net Uncertainty Forecast and
Commitment Threshold/Short-Term Reserve Requirement

| | Commitment | Short-Term Reserve |
|---|---|---|
| Net Uncertainty Forecast | Threshold | Requirement |
| LOW (Green Zone) | Low | Normal |
| MEDIUM (Yellow Zone) | Medium | |
| HIGH (Red Zone) | High | Emergency |

Testing of the uncertainty forecast performance highlighted improved embodiments. The first improvement involves refining existing machine learning models through hyperparameter tuning and advanced feature engineering. For instance, based on post-processing observations for prescriptive analysis, improved embodiments utilize different sets of weighted features tailored to various seasons and expected weather patterns, particularly in extreme conditions such as extreme cold, heat, or high winds during shoulder seasons like fall and spring. Secondly, for an extreme weather that spans multiple days, improved embodiments utilize a different setting of lagged features in the forecast model. For instance, when having notable generation forced outage during a multi-day extreme weather event, it seems reasonable to expect the forced outage MW should come down as the generation owners may have improved their generation availability throughout an event. Third, envisioned embodiments may include net scheduled interchange and generation outage forecasts as external regressors for net uncertainty forecast model to further improve the forecasting ability of the system.

Additionally, to enhance forecasting capabilities, embodiments are incorporating probabilistic forecasting and scenario development. Probabilistic models provide a more robust alternative to traditional point forecasts by offering a range of possible outcomes with associated probabilities, which better capture the inherent uncertainties in net uncertainty forecasting. This approach improves risk assessment, reserve management, and decision-making in power system operations by incorporating uncertainty into the process. Techniques such as Monte Carlo simulation, quantile regression, and Bayesian models generate multiple scenarios, allowing operators to prepare for various potential futures and optimize resource allocation. The inclusion of weather-related features, load forecasts, and renewable energy predictions further strengthens the effectiveness of these models, making probabilistic forecasting beneficial for resilient and cost-effective power system management.

The above discussion underscores the advantages of employing multiple deterministic forecast models, which enhance the accuracy of uncertainty predictions through cross-validation and provide a more reliable foundation for decision-making in unit commitment processes.

Intelligent Decision Making. Embodiments of the platform utilize reinforcement learning to make automated or semi-automated, optimal forecasting decisions for grid controller's multi-day operations. Similar techniques may also be applied to day-ahead and real time market operations. Compared to the prior art forecasting decision-making processes, the disclosed method will make more traceable, timely, and forward-looking decisions with optimality and high confidence. This platform will also make optimal selection and combination of forecast scenarios with uncertainty. The improved point forecast, uncertainty distribution and probabilistic scenarios will feed into operational decision tools to evaluate additional uncertainties from transmission congestion. Together, the methods will greatly improve the uncertainty quantification from forecast and transmission constraints. The platform will greatly improve situational awareness, and preventive and intelligent decision-making especially under emergency conditions.

Energy Forecast Analytical Framework. Embodiments of the platform may include an energy forecast analytical framework to dynamically select and combine load/solar/wind forecast scenarios and quantify uncertainties. This embodiment is able to pinpoint one or a few operational scenarios, amongst tens, hundreds, or thousands of scenarios, and to accurately quantifying the associated risks. The framework makes use of a reinforcement learning based forecast scenario selection method. Additionally, the framework integrates a Bayesian model averaging method to optimally combine forecast scenarios. An outcome of the framework is a quantile neural network to quantify forecast uncertainties and generate probabilistic scenarios. The framework collects forecasts from multiple vendors, forecasts from multiple models and data concerning confidence interval and past performance to output operating net-load scenario and risks.

Dynamic short-term-reserve (STR) Requirements. Embodiments of the platform may provide STR requirements and default recommendation. As shown in FIG. 18, the platform would perform a simulation to establish STR demand curve from three components of uncertainty based on historical operational data: (1) Non-Intermittent Gen+Reg MW; (2) Gen OU/Derate; and (3) Real Time Commitment. Next, the platform will establish cluster of hour and season based on simulated STR demand curve: 3 cluster of hour (low/medium/high); 4 season. Next, the platform will establish STR requirements based on season and hour cluster: Normal Day (cover 97.14% risk for system wide); Additional adder for Tight Day (cover 99% of risk). FIG. 18 explains an exemplary flow for simulating STR.

Dynamic Regulation Requirements. Key tasks for providing a dynamic process to set Regulation Requirement based on quantified net uncertainty: Task 1: Uncertainty quantification—Quantify the uncertainty that should be covered by Regulation Reserve product; Task 2: Derive Regulation Reserve Requirement—Monthly requirements (Normal/High): vary by hour and weekday/weekends; Task 3: Dynamic Process—Design a process to dynamically set requirement (Normal/High) based on predicted uncertainty.

In response to shift in generation fleet and uncertainty profiles, an embodiment provides methodology to quantify the net uncertainty for Regulation timeframe and to derive the Regulation Reserve requirement, a key market aspect to manage real-time uncertainty. An exemplary methodology of quantifying net uncertainty includes two components as below. Component 1 represents the Area Control Error that MISO utilizes Regulation Reserve to balance, and Component 1 represents the uncertainty of the Regulation Reserve due to non-performance issue.

### Task 1: Net Uncertainty Quantification

### Component 1:

for each 4-see interval:

$$Uncertainty = - {( N A I - N S I )}_{t} + Regulation {Actual}_{t - i}$$

$$where$$

$$N A I = Net Actual Interchange$$

$$N S I = Net Scheduled Interchange$$

$$Regulation Actual = Response to Regulation Deployment$$

This embodiment includes the Tie Error (NAI-NSI) in uncertainty as it is trying to move generation to bring Actual Interchange close to the scheduled interchange. This embodiment shifts the Regulation Actual by one interval as the effect to deploying Regulation in t−1 interval is reflected in the -(NAI-NSI) in next interval t. This embodiment calculates a rolling average over 75 intervals to smooth the volatility of quantified uncertainty

### Component 2:

Calculate Regulation MW shortage due to ramp sharing, including shortage during Ramp-Up and Ramp-Down separately (from UDS case)
Tracking units that have cleared Regulation MW

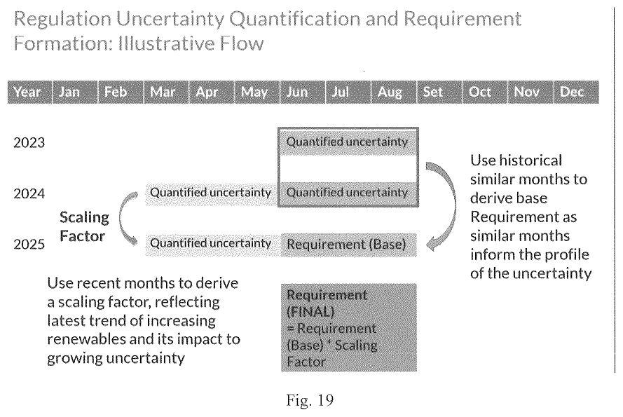

Once net uncertainty is quantified, an embodiment translates the quantified uncertainty to the Regulation Reserve requirement as illustrated in the steps below. A key design feature for this embodiment is the scaling factor, which is used to scale-up the Reserve Requirement based on the latest trend of growing renewable and its impact to uncertainty profiles. The illustrative flow chart of FIG. 19 provides a high-level overview of a controller's uncertainty quantification and requirement formation process for Regulation Reserve.

### Task 2: Translating the Quantified Net Uncertainty to the Regulation Requirement

Component 1: Tie Error requiring continuous deployment of Regulation (Normal Requirement: 95th percentile; High Requirement: 97th percentile)
Component 2: Regulation Capacity not available for deployment because of ramp sharing (Average)

### Equation for Deriving Regulation Requirement:

$$[ Component 1 ( 95 / 97 percentile ) + Component 2 ( Average ) ] * scaling factor$$

Step 1: find 95% and 97% percentile of quantified uncertainty for each month-hour:

$$Uncertainty = - {( N A I - N S I )}_{t} + Regulation {Actual}_{t - l}$$

This step derives the first term of requirement as 12 month*24 Hour values for weekday and weekend separately

Step 2: Find the average Regulation shortage (max of Ramp-Up and Ramp-On) for each month-hour. This step derives the second term of requirement as with 12 month*24 Hour values for weekday and weekend separately

Step 3: Add the first and second component together as Base Regulation Requirement before adjustment to account for continued renewable growth

$$Base Regulation Requirement = {Uncertainty}_{q , m , h} + Ramp Sharing Reg {Shortage}_{m , h}$$

$$Where q , m , h = quantile , month , hour$$

Step 4: Add final adjustment to account for latest trend of growth in renewable installed capacity and its impact to growing uncertainty

$$Final Regulation Requirement = Base Regulation Requirement * adjustment scaler$$

$$Where , adjustment scaler = growth of uncertainty in latest months$$

Dynamic Ramp Requirements. In response to shift in generation fleet and uncertainty profiles, an embodiment provides a methodology to set the requirement of Ramp Capability Product, with the focus on changing the Uncertainty Component from a fixed constant to 24 hourly values. To ensure the additional cost of procuring more Ramp Capability does not out-weight the benefit of the potential reduction of reserve shortage penalties, the embodiment conducts cost-benefit analysis for setting the appropriate level of requirement.

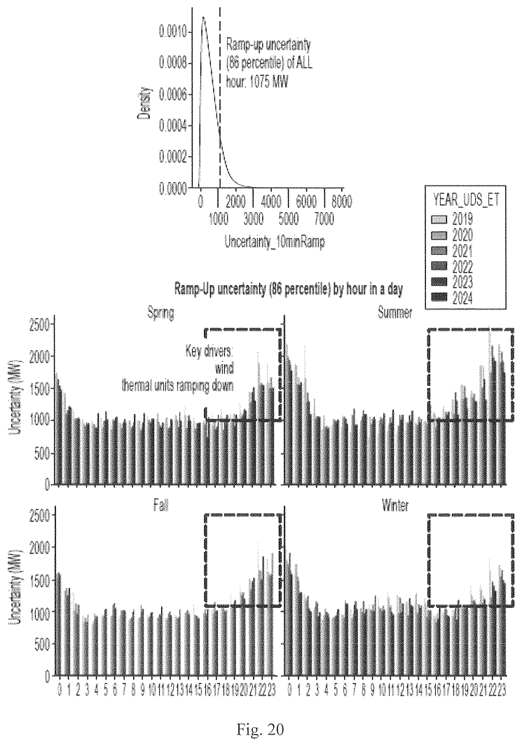

FIG. 20 shows that, in practice, a materialized 10 minute ramp-up uncertainty (86 percentile) has exceeded 1075 MW during most evening hours.

### Ramp Capability Product Variability Calculation and Uncertainty Quantification.

### Variability Component.

$$Net load\_ [ t + 10 ] - net load\_ [ t ]$$

Where, Net load change includes load forecast, renewable generation, and net scheduled interchange.

Uncertainty component. Quantification: Compare scheduled ramp rate for energy in “LAC interval 10-25 min” and the corresponding energy ramp in UDS. Currently set as a constant at 1075 MW, which corresponds to 86% ramp uncertainty threshold as in a conducted cost-benefit analysis shown in FIG. 20.

An embodiment provides a dynamic process to set the Ramp Capability Product Requirement (Uncertainty Component). Task 1: Uncertainty quantification—quantify the uncertainty component. Task 2: Derive Requirement for Uncertainty Component—Cost-benefit Analysis to set uncertainty threshold for Low/Medium/High requirement for uncertainty component. Task 3: Dynamic Process to dynamically set requirement for uncertainty component (Low/Medium/High) based on predicted uncertainty. Near term: dynamically set requirements through operating process/procedure based on anticipated ramp uncertainty. Longer term: develop an uncertainty prediction Machine Learning model in Uncertainty Platform.

Intra-Day Net Uncertainty Prediction Models. In an embodiment, Intra-Day Net Uncertainty Machine Learning and Artificial Intelligence models are similar to the Net Uncertainty Forecast models, but with a focus of intra-day (next few hours) instead of next few days. Such analytical models are able to dynamically set STR reserves, Regulation Reserves and Ramp Product Reserves for the next few hours.

Forecast Switching and Blending. Embodiments of the disclosure provide a data-driven, AI-based decision-making system to dynamically select or blend between two external forecasting vendors for 10-minute-ahead renewable energy forecasts. The embodiment improves forecast accuracy by either switching in real-time to the more accurate vendor or using an AI ensemble approach to generate an optimized blended forecast.

For example, controllers may desire to select between two vendors to provide short-term forecasts for renewable energy generation-primarily wind and solar. For example, Vendor 1 has demonstrated superior performance compared to Vendor 2; however, recent operational data show that Vendor 2 has made significant improvements, particularly in forecasting solar generation. This shift opened the opportunity to leverage Vendor 2's improved performance selectively, especially in cases where Vendor 1 may underperform.

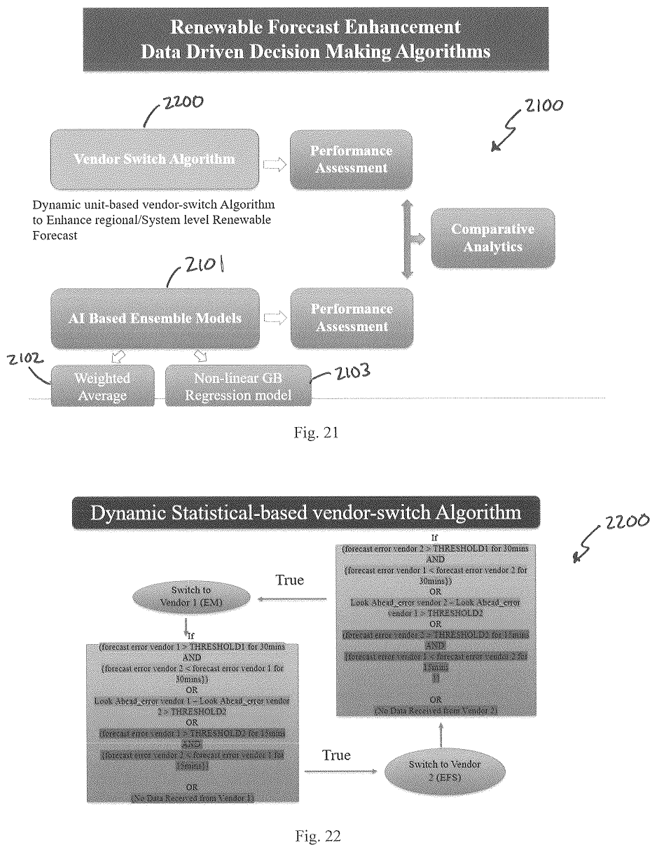

To address this, in an embodiment, two complementary models are provided as shown in FIGS. 21 and 22: 1. A real-time vendor switching algorithm 2200, based on historical performance analysis and threshold-based decision logic. An AI-based ensemble model 2100, blending both vendors' outputs using machine learning techniques to generate an improved forecast.

Real-Time Vendor Switching Algorithm 2200. This model is a rule-based system to determine, in real time, which vendor's forecast to use for each spatial renewable unit. Components: (A) Exploratory Data Analysis (EDA)—Extensive historical performance analysis identifies patterns in forecast accuracy. This includes examining: (1) Seasonal and event-driven vendor performance fluctuations; (2) Bias tendencies (over- vs under-forecasting) in each vendor; (3) Error distributions and outlier behavior; and (4) Auto-regressive characteristics of forecast errors-how much past forecast performance can influence near-future accuracy. (B) Threshold Definition—Forecast error thresholds based on statistical distributions (percentiles) of historical errors for each vendor. This enabled identifying situations where one vendor significantly deviates from expected performance. (C) Switching Logic—Vendor switching decisions made at the individual renewable unit level. When one vendor's forecast error exceeded its dynamic threshold, the system switches to the alternate vendor for that time step and location. The results are then aggregated across the controller's system to assess overall regional improvement. This spatially granular approach significantly improved the switching algorithm's effectiveness, especially when evaluating cumulative system performance.

AI-Based Ensemble Forecasting 2100. To further enhance accuracy beyond simple vendor selection, a machine learning ensemble framework 2101 is provided. Two AI-based strategies are implemented: (1) Probabilistic Weighted Averaging 2102—A classification model trained to predict which vendor would be more accurate at each time step. The model's predicted probabilities are then used as dynamic weights in a weighted average of both vendors' forecasts. (2) Gradient-Based Nonlinear Regression 2103—A gradient boosting regression model trained using historical data, including features from both vendors' forecasts, time-based attributes, recent error history, and autoregressive features. The model learns to output an optimized forecast for 10-minute-ahead predictions by non-linearly combining signals from both vendors.

Model Evaluation. Both the vendor switch algorithm 2200 and the ensemble models 2101 were validated using a full year of historical forecast and actual generation data. Performance was measured using standard error metrics such as MAE and RMSE. The vendor-switching model 2200 consistently outperformed both individual vendors by leveraging the situational strengths of each. The AI ensemble models 2101, particularly the gradient-based model 2203, demonstrated superior performance to the vendor-switch algorithm, achieving the lowest overall forecast error. This dual approach supports a scalable, intelligent forecasting architecture for real-time energy operations, with high potential for operational integration in system-wide renewable forecasting.

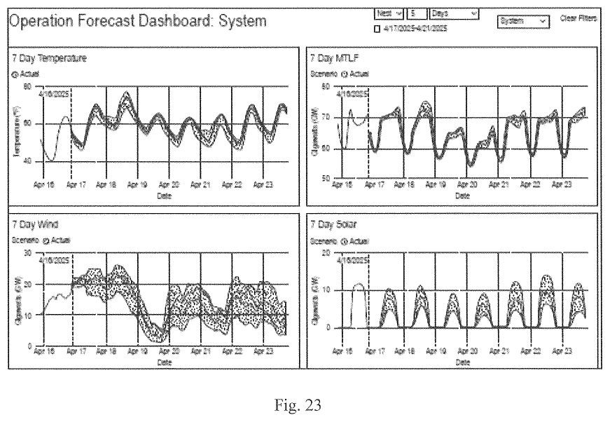

Customized Outputs. Multiple scenarios are produced via the Uncertainty Platform. As shown in FIG. 23, on a main page of operations forecasting dashboard display, a few key scenarios with uncertainty bands are visualized, where the key scenarios could be blends of different weather or vendor forecasts for different regions.

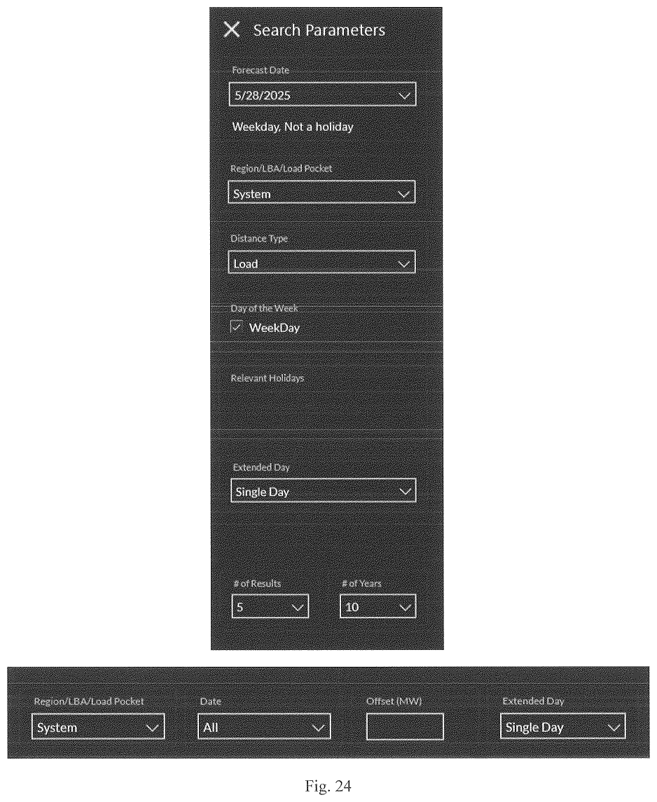

User Interfaces. An embodiment of the Uncertainty Platform provides user interfaces (which may be graphical user interfaces) with the following features. As shown in FIG. 24, Users have options to go from overview (key scenarios+uncertainty band) to detailed pages with all scenarios; Users have options to designate different scenarios as production scenarios; Users have options to add offset to different scenarios; Users have options to produce risk assessments by specifying fuel types, regions and etc.; and Users have options to interact and filter data to further their analysis capabilities.

The disclosed computing engines, modules, machine learning modules, machine learning engines, training systems, algorithms, architectures and other disclosed functions may be embodied as computer instructions that may be installed for running on one or more computer devices and/or computer servers. Such computing devices/servers may include display devices connected (via a data connection) thereto for providing one or more the displays contemplated herein; and such computing devices/servers may include input devices (via hardware, such as keyboards, touch-screen displays, mouse components and the like) allowing users to interact with the computing devices/servers and graphical user interfaces as contemplated herein. In some instances, a local user can connect directly to the system; in other instances, a remote user can connect to the system via mobile computing device over a network.

Example networks can include one or more types of communication networks. For example, communication networks can include (without limitation), the Internet, a local area network (LAN), a wide area network (WAN), various types of telephone networks, and other suitable mobile or cellular network technologies, or any combination thereof. Communication within the network can be realized through any suitable connection (including wired or wireless) and communication technology or standard (wireless fidelity (WiFi®), 4G, 5G, long-term evolution (LTETM)), and the like as the standards develop.

The computer device(s) and/or computer server(s) can be configured with one or more computer processors and a computer memory (including transitory computer memory and/or non-transitory computer memory), configured to perform various data processing operations. The computer device(s) and/or computer server(s) also include a network communication interface to connect to the network(s) and other suitable electronic components.

Example local and/or remote user devices can include a personal computer, portable computer, smartphone, tablet, notepad, dedicated server computer devices, any type of communication device, and/or other suitable compute devices.

The computer device(s) and/or computer server(s) can include one or more computer processors and computer memories (including transitory computer memory and/or non-transitory computer memory), which are configured to perform various data processing and communication operations associated with providing various functionalities of the disclosed Uncertainty Platform over the network, from a user and/or from a storage device. In some implementations, storage device can be physically integrated to the computer device(s) and/or computer server(s); in other implementations, storage device can be a repository such as a Network-Attached Storage (NAS) device, an array of hard-disks, a storage server or other suitable repository separate from the computer device(s) and/or computer server(s).

Having described the inventions by way of example embodiments, it will be apparent to those of ordinary skill that all such embodiments described herein are not intended to be limiting. Further, it is expected that the appended claims terms should be construed according to their plain and ordinary meanings in the relevant technical field unless such terms are otherwise expressly defined herein. It should also be recognized that words or phrases of emphasis, such as “key,” “important,” “primary,” and so forth are not intended to be limiting, but only to emphasize concepts in the various examples disclosed.

The Uncertainty Platform embodiments, and associated systems and methods disclosed herein may comprise, consist of, or consist essentially of the elements of such Uncertainty Platform, systems and/or methods as described herein, as well as any additional or optional elements described herein or otherwise useful in the manufacture or use of the Uncertainty Platform, systems and methods as disclosed.

What is claimed is:

1. A computer implemented platform for managing risk and uncertainty for energy grid operators, comprising:
a forecasting application providing probabilistic forecasts or uncertainty quantification for load, weather, and renewable-energy forecasting aspects;
a risk analytics and visualization application providing availability risks of generation, fuel and net scheduled interchange and displaying at least portions of the availability risks in a geographic overlay; and
a net uncertainty application dynamically setting reserve requirements based on periodic risk profiles.

2. The computer implemented platform of claim 1, further comprising a cloud-based storage architecture, that serves data to the platform in raw, enhanced and enriched states.

3. The computer implemented platform of claim 1, wherein the net uncertainty application utilizes a machine learning model to provide a predicted daily risk profile.

4. The computer implemented platform of claim 3, wherein the machine learning model predicts high, medium or low uncertainty levels based on which normal or high reserve requirements will be set for the day-ahead and real-time markets.

5. The computer implemented platform of claim 4, wherein the machine learning model comprises one or more of:
a tree-based machine learning model; or
a deep neural network model.

6. The computer implemented platform of claim 4, wherein the machine learning model comprises a feature engineering gradient model that ties multiple approaches to build a set of features to forecast net uncertainty.

7. The computer implemented platform of claim 6, wherein the set of features comprise:
lagged features;
seasonality features, including indicators for daily, weekly and seasonal patterns;
non-linear and interaction terms; and
external regressors.

8. The computer implemented platform of claim 7, wherein external regressors include one or more of wind forecast, solar forecast, load forecast and weather forecast.

9. The computer implemented platform of claim 4, wherein the machine learning model comprises a feature engineering in deep neural network model that incorporates regressors, autoregressive inputs and time-based features.

10. The computer implemented platform of claim 9, wherein the regressors represent factors including one or more of weather conditions, load forecast and weather forecast.

11. The computer implemented platform of claim 9, wherein the time-based features include weather-based seasonality components.

12. The computer implemented platform of claim 3, wherein the machine learning model generates a time series forecast of uncertainty in MW at a predetermined time-based granularity.

13. The computer implemented platform of claim 12, wherein the time series forecast of uncertainty is translated into low, medium or high levels of uncertainty.

14. The computer implemented platform of claim 1, wherein further comprising application programming interfaces providing exchange of communication between cloud-hosted applications of the platform and on-premises operations of the platform.

15. The computer implemented platform of claim 1, wherein the forecasting application utilizes historical quantifications of net uncertainty.

16. The computer implemented platform of claim 1, wherein the forecasting application utilizes an overlay of solar forecast and cloud-cover forecast to predict rapid changes in solar penetration.

17. The computer implemented platform of claim 1, further comprising an application producing dynamic commitment reserve margins.

18. The computer implemented platform of claim 1, wherein output from the forecasting application and the risk analytics and visualization application are provided in a single user interface display.

19. The computer implemented platform of claim 1 further comprising:
a computer-display fail-to-start dashboard that combines the following inputs,
temperature threshold information from market participants indicating temperature thresholds at which generators would likely fail to start,
temperature forecasts across a multitude of weather stations in a controller's geographic region, and
unit commitment information in which generators are scheduled to be online for various time periods; and
displays a geographic map overlayed with visual fail-to-start risk information.

20. The computer implemented platform of claim 1 further comprising a computer-display gas pipeline dashboard that provides a visualization of a gas pipeline network that covers a geographic region of the energy grid operator with visual generation-at-risk information associated with the gas pipeline network.

21. The computer implemented platform of claim 1, wherein one or more of the forecasting application, the risk analytics and visualization application and the net uncertainty application provide multiple deterministic forecasting models for allowing cross-validation of uncertainty predictions or understanding ranges of possible outcomes.

22. The computer implemented platform of claim 1, wherein the net uncertainty application quantifies net uncertainty as the difference between real-time and day-ahead forecast in forward reliability assessment commitment (FRAC) process.

23. The computer implemented platform of claim 22, wherein net uncertainty is calculated as follows:
$$Net Uncertainty = Δ Generation - Δ Load + Δ Wind + Δ Solar + Δ N S I - StrandedMW , \qquad ( Eq . 1 )$$
$$where Δ = Actual - Forecast at FRAC$$
wherein,
ΔGeneration tracks the change in “available non-intermittent generation capacity” or the availability of conventional thermal generation,
ΔLoad, ΔWind and ΔSolar quantify the uncertainty from forecast error of load, wind and solar generation
ΔNSI quantifies the uncertainty of the grid operator's Net Scheduled Interchange (NSI) with neighboring grid operators, and
StrandedMW is the generation MW unavailable for meeting load due to transmission constraint. By including this term, the model is forecasting transmission congestion in the net uncertainty forecast process.

24. The computer implemented platform of claim 1, wherein one or more of the forecasting application, the risk analytics and visualization application and the net uncertainty application includes an energy forecast analytical framework based on reinforcement learning to dynamically select and combine load forecast, solar forecast and wind forecast scenarios and quantify uncertainties and pinpoint an operational scenario among many possibilities.

25. The computer implemented platform of claim 1, wherein the uncertainty application is further configured to provide dynamic regulation requirements based on quantified net uncertainty.

26. The computer implemented platform of claim 1, wherein the uncertainty application is further configured to provide dynamic ramp requirements based on quantified net uncertainty.

27. The computer implemented platform of claim 1, wherein one or more of the forecasting application, the risk analytics and visualization application and the net uncertainty application is configured to dynamically select or blend between two or more external forecasting vendors.
